(19) United States
(12) Patent Application Publication
(10) Pub. No.: US 2003/0028469 A1
(43) Pub. Date: Feb. 6, 2003

(54) Methods and apparatus for enabling an electronic information marketplace

(75) Inventors: Lawrence Bergman, Mt. Kisco, NY (US); Yuan-Chi Chang, Ossining, NY (US); Gary Koehler, Gainesville, FL (US); Chung-Sheng Li, Ossining, NY (US); Rakesh Mohan, Cortlandt Manor, NY (US); Jakka Sairamesh, New York, NY (US); John R. Smith, New Hyde Park, NY (US)

Correspondence Address: Ryan, Mason & Lewis, LLP, Suite 205, 1300 Post Road, Fairfield, CT, 06430, US

(73) Assignee: International Business Machines Corporation, Armonk, NY (US)

(21) Appl. No.: 09/895,944

(22) Filed: Jun. 29, 2001

(51) Int. Cl. G06F 17/60

(52) U.S. Cl. 705/37

(57) ABSTRACT

Techniques are provided for enabling an electronic information marketplace. Broadly, sellers and buyers can exchange information goods. The buyers request information goods and the sellers offer suitable information goods. One or more matches may occur between the requested and offered information goods. The information goods may be priced through any of a number of techniques, which include fixed and dynamic pricing methods. Importantly, requests and offerings can be annotated to help the matchmaking process. Additionally, concepts can be determined from the requested and offered information goods, which also facilitates the matchmaking. The matchmaking process itself can also determine inferences during matchmaking, which further improves the matchmaking.

### CROSS REFERENCE TO RELATED APPLICATIONS

This application is related to the U.S. patent application identified by Attorney Docket Number YOR920010407US1, entitled “Methods and Apparatus for Automatic Replenishment of Inventory Using Embedded Sensor System and Electronic Marketplace,” filed concurrently herewith.

### STATEMENT OF GOVERNMENT RIGHTS

This invention was made with Government support under Contract No. NASA/IBM CAN NCC5-305, awarded by the National Aeronautics and Space Administration (NASA). The Government has certain rights in this invention.

### FIELD OF THE INVENTION

The present invention relates to electronic marketplaces and, more particularly, relates to methods and apparatus for enabling an electronic information marketplace.

### BACKGROUND OF THE INVENTION

People are exposed to a wide variety of information goods on a daily basis. These information goods include books, newspapers, magazines, and audio and video tapes. Depending on the media on which they are delivered, information goods can be categorized into one of the following media types:

Paper: This includes newspapers, journals, magazines, and books.

Magnetic and optical media: This includes both analog and digital tapes containing audio or video or both, Compact Disk (CD), video CD, laser disk, and Digital Versatile Disk (DVD).

Electronic: This includes radio programs, television programs delivered through broadcast, cable, or satellite, online journals, Internet portals, books, and video and audio where the delivery mechanism is through the Internet.

The majority of the information goods shares the characteristics of high fixed cost for producing the first copy and small marginal cost for producing additional copies. As an example, the cost for producing a movie is usually on the order of 10 to 100 million dollars, while the DVD and Vertical Helix Scan (VHS) tape versions of the movie are usually sold for 10 to 20 dollars even though the production cost for each tape or DVD is much less than a dollar. Similar situations exist for CDs, records, books, magazines, and journals.

Information goods can be taxonomized into the following broad areas, based on how they are being consumed:

Packaged information goods: The information goods in this category are usually consumed in their entirety. Examples include articles from electronic journals, a song from a CD, and a movie from a DVD.

Component information goods: The information goods in this category are usually consumed and composed to produce new information goods. Examples include a mechanic design, an Application Specific Integrated Circuit (ASIC) design, an image clip, a video clip, and an audio clip. Multiple ASIC components can be integrated into a system-on-a-chip design. Similarly, image clips can be used to compose/mosaic a new image with those clips serve as the components.

Semantic information goods: The information goods in this category are usually used for inferring new information goods, which can then be consumed. Examples include the use of satellite images to infer an upcoming typhoon or disease outbreak, and the use of electronic journals to produce a business plan.

Based on this taxonomy, it can be observed that packaged information goods are usually consumed in the business-to-consumer context, as the consumer usually does not have the capability or desire to author new content or information. On the other hand, component information goods and semantic information goods are usually consumed in the business-to-business context.

Traditional techniques for packaging information goods are selling the goods through the retail channels (e.g., book and record stores and magazine stands). Price discrimination mechanisms do exist, such as having hard cover and soft cover versions of the same book in order to capture both content-oriented and value-oriented, respectively, consumers. “Bundling” also exists, such as when programming materials are bundled on cable television (e.g., basic versus premium). Locating the desired information goods usually involves browsing a catalog from a publisher, or browsing through shelves in a bookstore.

The introduction of Internet has fundamentally and dramatically altered the environment of producing and consuming information goods. There is growing disparity between the needs of information consumers and the capabilities and offerings of the data providers. Using earth science as an example, the five instruments onboard “Terra,” the Earth Observing System (EOS) that was launched during 1999, collect and transmit data to a ground station at a very high data rate. The Terra platform, in conjunction with other earth observing platforms, is providing extraordinary earth coverage for studies such as landscape change, the relationship between heat flow and climate, the relationship between sea surface temperature and climate, flooding and climate change, tracking air pollution, urbanization, and global warming. Different earth observing platforms, however, offer different spatial, temporal, and spectral resolutions and coverage.

As a result, it is extremely difficult to determine relevant data sources and locate the data for any given scientific study. This difficulty occurs in spite of the fact that the Global Change Master Directory (GCMD) has catalogued the majority of earth science related data sets. Furthermore, the majority policy makers and commercial users of earth science data are only concerned with the information derived from these data products (such as the location of disease outbreak, beach erosion, and the locations of the forest fire), rather than the data products themselves. Consequently, there is a huge gap between the needs of the end users and the offerings from the data providers. Currently, there are no mechanisms that can match buyers to offerers for information goods and yet also match buyers, who have only a broad generalization of the data they want, with sellers who have raw data.

There are currently existing exchanges where buyers and seller can meet. For instance, public exchanges already exist for stock and commodities, where bids and asks are matched by the exchange. Recently, new types of exchanges, such as Enron, for matchmaking of electricity and bandwidth have become available. However, these exchanges either match exact goods (such as stock and commodity exchange) or parameterized multi-attribute goods (such as electricity and bandwidth). None of these markets can handle information goods or match buyers and sellers of information goods.

There are applications that attempt to match inputted data with existing documents. Most existing information matchmaking applications are based on similarity retrieval of templates or examples, such as similarity retrieval of text and image documents. In such retrievals, the query usually consists of a number of keywords or phrases for text retrieval or features of an image for image retrieval. However, these simplistic applications are not suitable for buyer and seller matching in an information good context. For instance, in the Terra example related above, the policy makers desire concepts that are determined from a very large amount of raw data. The matchmaking applications simply compare inputs to data and are not suitable for determining or matching concepts.

A need therefore exists for allowing buyers and sellers of information goods to exchange information goods, particularly when the information goods contain large amounts of information.

### SUMMARY OF THE INVENTION

The present invention provides techniques for enabling an electronic information marketplace. Broadly, sellers and buyers can exchange information goods. The buyers request information goods and the sellers offer suitable information goods. One or more matches may occur between the requested and offered information goods. The information goods may be priced through any of a number of techniques, which include fixed and dynamic pricing methods. Importantly, requests and offerings can be annotated to help the matchmaking process. Additionally, concepts can be determined from the requested and offered information goods, which also facilitates the matchmaking. The matchmaking process itself can also determine inferences during matchmaking, which further improves the matchmaking.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary structure of an electronic marketplace, and its relationship to information providers, service providers, and information consumers, in accordance with one embodiment of the present invention;

FIG. 2 illustrates exemplary relationships among providers, intermediaries, and consumers in a multilevel marketplace structure, in accordance with one embodiment of the present invention;

FIG. 3 illustrates a sell-side (e.g., one seller, multiple buyers) private marketplace, in accordance with one embodiment of the present invention;

FIG. 4 illustrates a buy-side (e.g., one buyer, multiple sellers) private marketplace, in accordance with one embodiment of the present invention;

FIG. 5 illustrates a multiple buyers, multiple seller public marketplace, in accordance with one embodiment of the present invention;

FIG. 6 illustrates a process of extracting multiple versions from data, as well as extracting features, semantics, and concepts from the data, in accordance with one embodiment of the present invention;

FIG. 7 illustrates a process for an information provider to set up a sell-side marketplace and for a seller to shop offerings, in accordance with one embodiment of the present invention;

FIG. 8 illustrates a process for creating “bundled” information goods for customers based on adaptive profiling, in accordance with one embodiment of the present invention;

FIG. 9 illustrates a process for the information provider to set up sell-side marketplace involving inferences, in accordance with one embodiment of the present invention;

FIG. 10 illustrates a process for a buyer to select information goods through a buy-side marketplace, in accordance with one embodiment of the present invention;

FIG. 11 illustrates a process for a buyer to select and inference information goods through a buy-side marketplace, in accordance with one embodiment of the present invention;

FIG. 12 illustrates a process for parsing concepts, and creating inferences from the concepts, that are needed to satisfy an Request for Information (RFI), Request For proposal (RFP), or Request For Quote (RFQ), in accordance with one embodiment of the present invention;

FIG. 13 illustrates a process of composing information goods to satisfy the requirements of RFI/RFP/RFQ, in accordance with one embodiment of the present invention;

FIG. 14 illustrates a process of composing information goods and creating inferences from information goods to satisfy an RFP/RFQ, in accordance with one embodiment of the present invention;

FIG. 15 illustrates a process of matchmaking in an exchange environment, in accordance with one embodiment of the present invention;

FIG. 16 illustrates a data model for annotating information and/or data, in accordance with one embodiment of the present invention;

FIG. 17 illustrates a Bayesian Network model for creating inferences of the risk of having a Hantavirus Pulmonary Disease outbreak for a house, in accordance with one embodiment of the present invention;

FIG. 18 illustrates an information “food chain” based on the model illustrated in FIG. 17, in accordance with one embodiment of the present invention; and

FIG. 19 shows a block diagram of a system suitable for implementing embodiments of the present invention.

### DETAILED DESCRIPTION OF PREFERRED EMBODIMENTS

In general, there are three types of players in an electronic marketplace. Some players are fixed-price producers of information goods, while other players are producers that offer their information at competitive prices, and still other players are expected utility maximizing consumers. As defined and used herein, an “information good” is a good that can be distributed in digital form.

For many markets, end consumers of information post requests for proposals (RFPs). Potential suppliers respond with tentative conditions and questions. Based on these, an end consumer produces a request for price quotes (RFQ). Firms respond and one or more are selected by the consumer. Winning firms may have formed a web of possible suppliers of information in a similar RFP/RFQ manner. As is often the case in business, it can be assumed that consumers tell other potential consumers about the quality and value of the products from the producer and that producers share payment histories on consumers. Hence, there is some basis to form opinions about the private information of players.

Most of the RFP/RFQ mechanisms in the existing commercially available electronic marketplaces are entirely based on non-structured free-text specifications. Alternatively, these mechanism provide, through a binding, an entry in a catalog that defines the attributes of the RFP/RFQ. The free-text approach makes the matchmaking between offerings and requests extremely difficult due to lack of context. The catalog approach, on the other hand, is too restrictive in terms of the capabilities for specifying the need. As an example of a catalog approach, the offerings of earth science related data products are mostly in the form of catalog, such as the Global Change Master Directory (GCMD). The latter provides both query and portal interface of descriptions of wide varieties of data sets related to global change research.

More specifically, the aspects of the inventions include the following:

(1) Human-assisted objective/goal decomposition: Unlike solving a Structured Query Language (SQL) query, the parsing and decomposing of a troubleshooting objective in general is extremely difficult. In this invention, an embodiment uses a knowledge template to specify a problem that needs to be decomposed or parsed. For example, a template can include the following: a problem domain (such as computer hardware or software problems, tax preparation, response to an archive system for Mayo Clinics); requirements (such as 30 percent of the retrieval of patient X-ray has to be completed within 15 minutes while 70 percent of the patient X-ray can be retrieved overnight); and an a priori knowledge-base, which includes possible decomposition methods provided by the users who are solving the problem.

(2) Information or knowledge exchange infrastructure: where the information or knowledge and its associated metadata is “traded.” Metatdata is used to describe the information or knowledge, and is technically defined as data about data. This information or knowledge can be traded using either fixed pricing, auction, or reverse auction formats. The components in this infrastructure can include the following: data sources; a data requester; and a matchmaking mechanism. The data sources can be, illustratively, either in the form of sensors for data and information acquired in real-time or information or knowledge archives. The data requester stores the information or knowledge that is to be sought. The matchmaking mechanism this is an important component in this infrastructure, in which relevant information or knowledge pieces from data sources are matched with the data requester. Note that similar to real-world merchandise, exclusivity of the information or knowledge can also be enforced. Consequently, information or knowledge can be auctioned or sold to the highest bidder. The highest bidder therefore exclusively owns the knowledge. Furthermore, the value of the information or knowledge may also be dependent on the certainty of the information, which may include credibility of an information source.

(3) Information or knowledge broker: Similar to real-world trading and auctioning, a broker mechanism may exist to help the information or knowledge seeker or data sources. On the side of the requester, multiple information or knowledge requesters may “aggregate” together to leverage their “buying power.” Meanwhile, brokers may also provide aggregations of the information or knowledge provider side to increase the appeal of the data source side.

What has been described so far is an exemplary infrastructure where data, information, and knowledge are “traded.” The following are assumed: (1) the syntactic and semantic annotations of the data sources and the requests exist; and (2) knowledge models are available that enable the entities or concepts of the requests to be inferred from the entities or concepts of the offered data, information, or knowledge. The data, information, and knowledge can then be traded using either fixed or dynamic pricing schemes. A matchmaking engine may be a search and inferring engine that is capable of performing content-based search of the offered entities and concepts, and capable of drawing inferences if the data, information, and concepts from the offered entities and concepts are not directly applicable to those from the requests. In other words, a matchmaking engine in accordance with one embodiment of the present invention can infer concepts from source data. The inferences help to match the source data to the requests. Inferences may also be developed from the requests.

The pricing of the data, information, and knowledge can be based on fixed or dynamic pricing schemes. Different data sources usually offer a wide range of temporal, spatial, and spectral resolution. Improved temporal, spatial, and spectral resolution can be achieved through interpolation or creating inferences from spatially, temporally, or spectrally adjacent data. In either of the mentioned pricing schemes, the matchmaking mechanisms herein will try to maximize the quality of the information content while maintaining a given budget for the information consumer. Note also that the data sources could be dynamic such that they contain up-to-the-date information. For example, the data gathering system of the U.S. patent application identified by Attorney Docket Number YOR920010407US1, entitled “Methods and Apparatus for Automatic Replenishment of Inventory Using Embedded Sensor System and Electronic Marketplace,” filed concurrently herewith and incorporated by reference herein, may be used to gather data.

This innovative infrastructure is applied to alternative earth science data herein. The present invention may be applied to many different data areas, but the earth science area will be used herein to highlight aspects and features of the present invention. This example infrastructure enables consumers to locate and tradeoff possible alternative earth science data and information sources in an electronic marketplace setting. Specifically, this architecture provides mechanisms to annotate the requests and offerings of the data and information products, and to decompose the concepts of the requests and offerings. This facilitates the matchmaking and inferencing. Based on the knowledge models developed for each application domain and science discipline, the matchmaking mechanism will be able to fuse and combine multiple alternative data and information sources so that the quality of the results can be maximized while the cost for data acquisition is minimized.

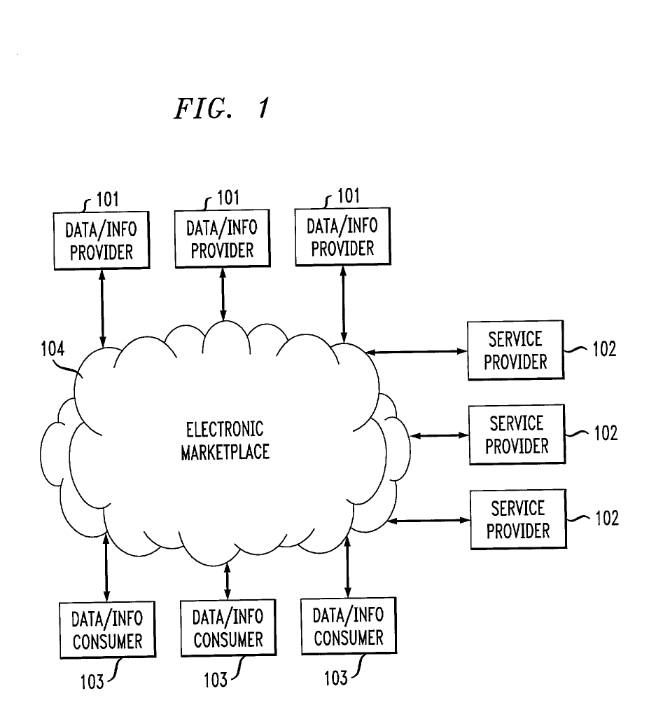

Turning now to FIG. 1, this figure shows a schematic of an electronic information marketplace. The participants of such a marketplace include the following: data/information providers 101, which provide the information and or data; service providers 102, which provide services to transform data from one format to another, to extract metadata from the data, and to create inference information from data; data/information consumers 103, which consume the information or data; and market makers 104, who provide the matchmaking and pricing mechanism for the consumers 103 to locate and acquire the information goods from the data providers 101, potentially with the help from the service providers 102.

As shown in FIG. 2, the logical structure of the supply chain of the information goods can be formed with multiple layers of intermediaries 202, 203 situated between providers 201 and consumers 204 of information goods. Even though an information marketplace can assume many different logic structures, due to the possibility of arbitrary number of intermediaries 202, the relationship between adjacent layers of the supply chain should involve a provider 201 and a consumer 204. All of the providers 201, intermediaries 203, and consumers 204 of the information goods, nevertheless, can all be connected to the same electronic marketplace, as shown in FIG. 1.

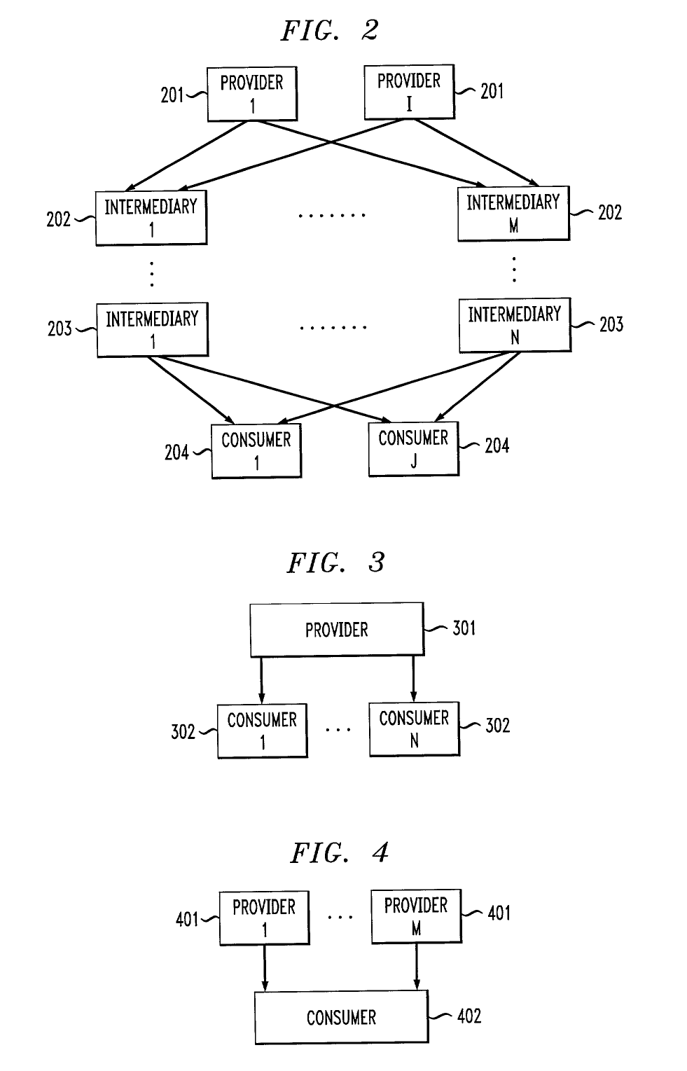

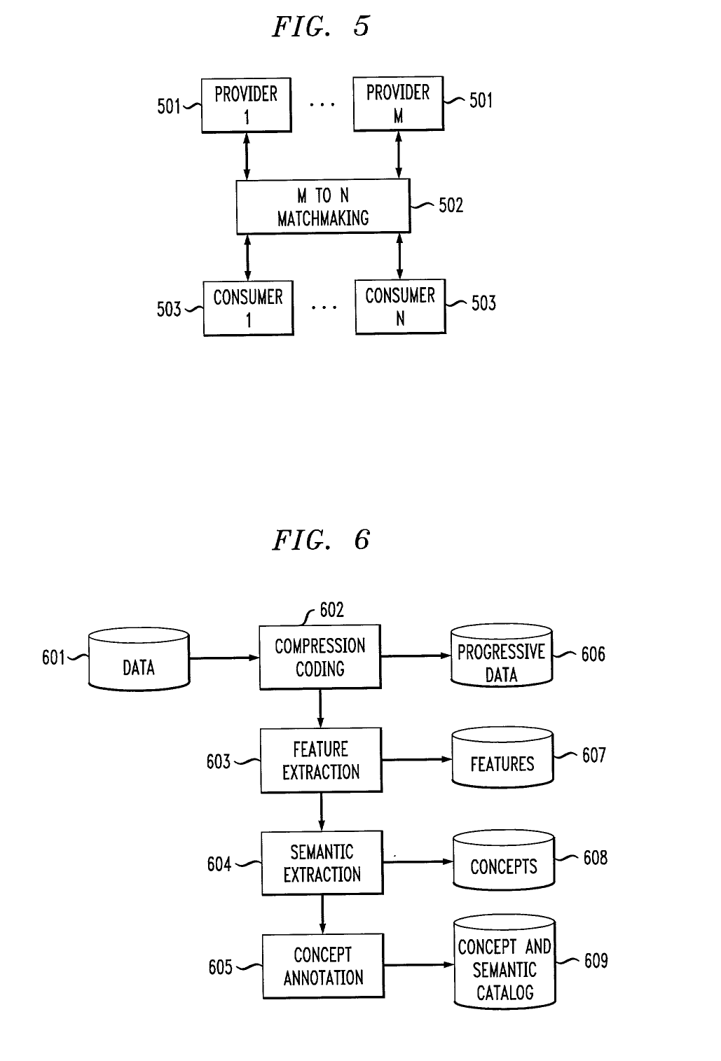

The structure of a marketplace can be further divided into three types. These types are illustrated by FIGS. 3 through 5. Referring to FIG. 3, a sell-side private marketplace is shown in which there is only one seller or provider 301 and multiple buyers or consumers 302. Turning to FIG. 4, a buy-side private marketplace is shown in which there are multiple sellers 401 and one buyer 402. Referring to FIG. 5, a public marketplace is shown in which a matchmaking mechanism 502 brings multiple sellers 501 and multiple buyers 503 together and provides the matchmaking mechanism for the buyers and sellers. Instances of the electronic marketplace mechanisms described in FIGS. 3, 4, and 5 have already been developed for trading traditional goods.

Similar to traditional goods, it is possible to define a supply chain for information goods. Each stage of the information supply chain consumes input from the previous stage, and generates output for the next stage. Furthermore, multiple data sources can be composed through overlay, mosaics, data fusion, information fusion, or inferencing. As is known in the art, overlay comprises superimposing multiple images. A mosaic is created by putting an images together into one image, which is similar to what occurs when a puzzle is put together. The process of data fusion combines multiple data sources into a single source through a model, such as a linear model. The composition and inferencing of information goods can be based on common sense or domain-specific knowledge. Inferencing, as described in more detail below, can be deductive, inductive, and abductive.

An important focus of the present invention is a set of methods and apparatus that facilitates the composition and/or decomposition of information goods. Specifically, the set of methods and apparatus include mechanisms that (1) capture the requests of information goods, (2) capture the offerings of the information goods, (3) annotate the requests and offerings of the data and information products, (4) decompose, deduct, and inference concepts from the requests and offerings to facilitate the matchmaking, (5) matchmake between the requests and offerings, making inferences when necessary, and (6) price the information goods based on either fixed or dynamic pricing schemes.

In order to facilitate the filtering, matchmaking and pricing process for all of the three types of marketplaces disclosed in FIGS. 3 through 5, it is recommended that the data sources be annotated with much richer metadata. This metadata includes (1) a data model, (2) semantics and concepts, and (3) low-level features (such as textures and spectral histograms) that can be readily extracted from the raw data sources. These annotations will facilitate (1) the composition and decomposition of the information goods, (2) the decomposition of the request for information goods, and (3) the matchmaking between the requests and available data sources. The matchmaking and pricing mechanisms proposed in this invention match the concepts, semantics, and features from the requests with the concepts, semantics, and features from the offerings. Using domain-specific knowledge models (such as Bayesian Network), it is possible to inference the desired results from alternative data sources. Given the fact that different data sources have varying temporal, spatial, and spectral resolutions and coverage, the matchmaking and pricing mechanism will attempt to maximize the quality (i.e., minimize the uncertainty) of the composed information while minimizing the cost.

Referring now to FIG. 6, the figure shows an exemplary process of generating different versions of data as well as the rich metadata. Starting with the raw data or information 601, compression and coding techniques 602, such as wavelet or Sfgraph, can then be applied to the data to generate a progressive representation 606 of the data. This enables the possibility of price discriminating the end consumer based on the versions of the data. Versions with less fidelities will cost less, while versions of higher fidelity will cost more. Features 607, such as texture and spectral histogram for images, and motion for video, can then be extracted from the original data or progressively represented data 606. Various feature extraction algorithms 603 can be applied to extract the features. For instance, slopes (for time series), shapes, textures and spectral histograms (for images) may be extracted. These features can then be passed through classifiers 604 to extract semantics 608. Examples of semantic extraction 604 for images, for example, include the determination of the type and boundary of an object in an image. The features and semantics can then be used to derive concepts annotation 605. Examples of concept annotation/extraction 605 for images, for example, include the determination of whether an image is an indoor or outdoor scene, whether the image has only a natural landscape or, instead, has a man-made background. The outcome of the concept annotation 605 is a catalog 609 which contains semantics/concepts 608, features 607 and progressive data 606.

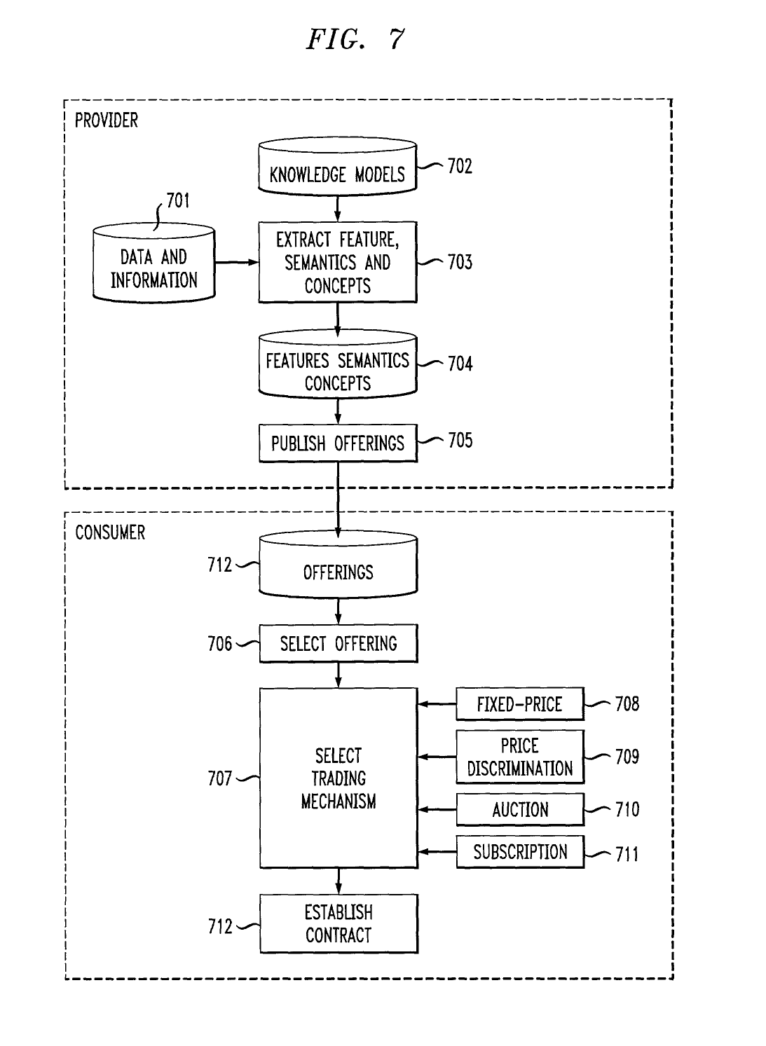

Turning now to FIG. 7, this figure shows a process for a producer of information goods to prepare offerings within a framework. This allows consumers to select from a number of offerings by the producer. For instance, published offerings could include satellite images along with various metadata that describe the images. The metadata could include, for example, descriptions of points of interest, histograms of water and soil, and boundaries of various geographical features. The features, semantics, and concepts 704 are extracted from the data and information 701. Knowledge models 702 may have to be used to extract semantics and concepts. For example, a knowledge model could indicate a color spectrum used to determine water amounts, such as having dark green indicate that the ground is saturated, whereas yellow indicates little or no water.

The extraction method 703 has been described in FIG. 6. The data or information in conjunction with the metadata are published 705 as available offerings 712. The publication process of offerings may involve populating a staging database before switching over the staging database into an operational database. The consumer of the information goods shops the desired information goods in step 706. This occurs usually through a filtering and searching mechanism provided by the producer of the information goods or provided by a third party. The consumer also selects an available trading mechanism and pricing plan in step 707. These trading mechanisms and pricing plans are fixed-price 708, price discrimination 709, auction 710, subscription 711.

Fixed price 708 is a system where there is one fixed price per information good. Price discrimination 709 is a system where the per-unit price varies with the number of information goods purchased. For instance, a satellite view, and its metadata, of a particular area on a particular day may be one price. A number of satellite views and their metadata of the same area but taken periodically over a long time period will be a larger price, but the price per information good will be smaller. Price discrimination 709 is common in many industries. An auction 710 is a system whereby the highest bidder is assigned the information good. Alternatively, auction 710 could be a “reverse auction,” where sellers attempt to meet a price set by a buyer. A subscription 711 is where a buyer offers to buy a certain number of issues of the information good. For example, a buyer could get satellite information every month for a year. Once the trading and pricing mechanism is selected, a contract (or something equivalent) that establishes the terms and conditions is signed between the provider and the consumer. This occurs in step 713.

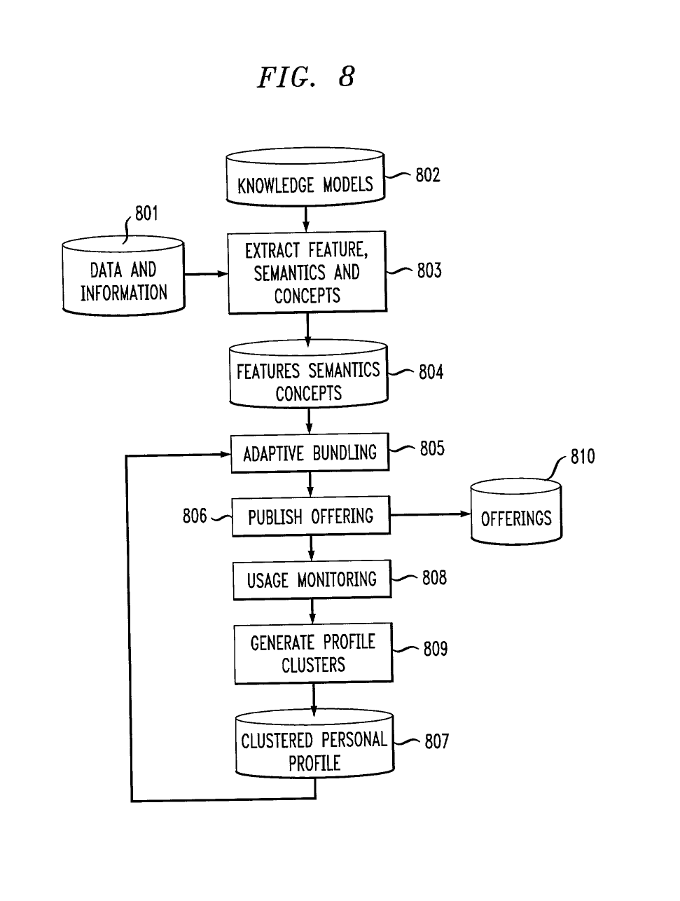

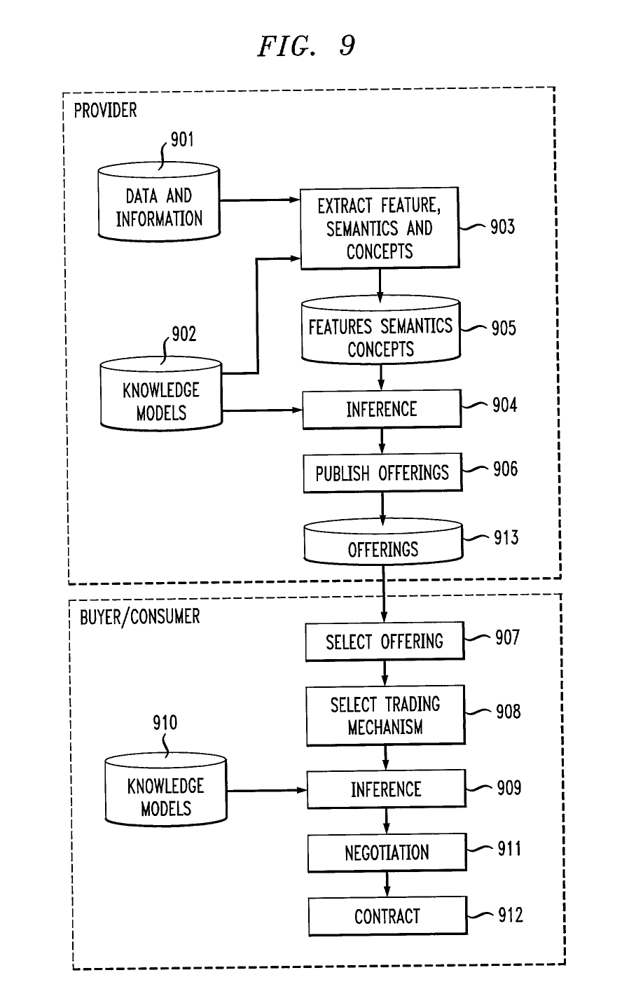

As opposed to FIG. 7, in which the data or information in conjunction with the extracted feature, semantics, and concepts are offered directly, the providers of the information goods may choose to bundle their offerings. It has been known in the literature that bundling tends to smooth the price-demand curve so that the consumer is less sensitive to the specific pricing. Examples of bundling include offering related articles or reports simultaneously to the subscribed users. For instance, along with a satellite image and its metadata, a consumer might also pay for an expert opinion of the satellite image. The expert opinion could be bundled with the satellite image. FIG. 8 shows a process using adaptive bundling of information goods. The “adaptive” bundling occurs because bundling is based on the evolution of customer interests. For instance, it could be discovered that a consumer not only wants an expert appraisal of a satellite image, but also wants an expert opinion, based somewhat on the image, of what is likely to happen in the future.

The first few steps of the method of FIG. 8 are similar to the previous case. The method illustrated in FIG. 6 (step 803) is used to prepare progressive version of the data and information 801 as well as extract features, semantics and concepts 804 from the raw data and information 801. Similar to the method introduced in FIG. 7, knowledge models 802 may be used to assist the extraction process. The user may already have specified his or her interests in a user profile (not shown). The user profile can be used to initially start the adaptive process in steps 805 through 809. Additional information can be extracted from the end users based on usage pattern and monitoring 808. The user profile (captured by explicit user specification) and the usage monitoring can be used to cluster 809 the consumers into broad categories 807. These categories can then be used to determine a “recipe” for bundling information goods, which is thus adaptive to the changing user needs. The offering 810 is published 806 after the determination of the bundling strategy.

In some cases, it becomes necessary for either the producer or the consumer or both to inference new information goods from existing offerings. In general, inferencing techniques include deductive, inductive, and abductive. Deductive methodology concludes a special case from a general case. Deductive techniques include logic programming, Bayesian networks, Dempster-Schafer's theory of evidence, and fuzzy sets. Inductive methodology concludes that a general principle is true because a special case is true. Inductive techniques include data mining (in particular the generation of association rules), statistical regression, neural networks, and decision trees. Abductive methodology inferences information and determines, from the information, the best explanation. Abductive techniques include those used for medical diagnosis, speech recognition, perception, and jury deliberation. In all three cases, new data, information, or knowledge is generated that cannot be discovered from the original data or information through traditional search and filtering techniques.

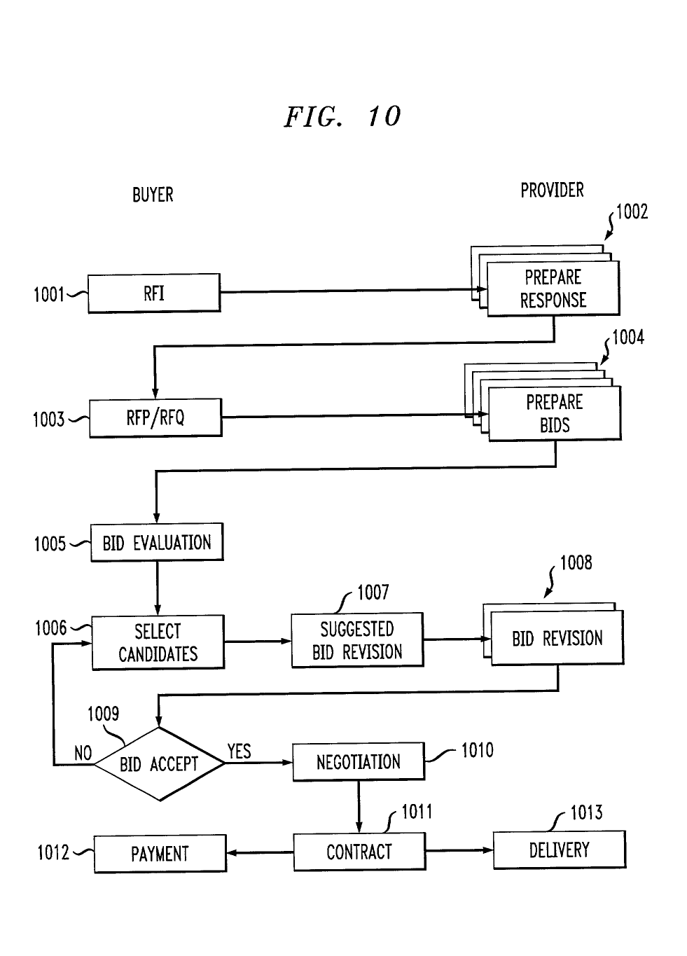

FIG. 9 shows a method and apparatus for providing inferenced information goods as offerings. The first few steps are similar to that of FIGS. 7 and 8. The features, semantics, and concepts 905 are extracted in step 903 from the raw data and information 901, potentially with the use of knowledge models 902. Additional information and knowledge will then be inferenced in step 904 from the extracted features, semantics, and concepts based on available knowledge models. All of the original data, information, extracted data, information, features, semantics, concepts, and inferenced data or information are then published in step 906 and become the offerings 913. The providers of the information goods may also choose to bundle the offerings as in FIG. 8. The consumers of the information goods may choose to shop the offerings as in FIG. 7. The consumers may also choose to inference from the offerings. In this case, the consumers first select the offerings 907, and then select the trading mechanism 908. In step 909, new information is inferenced based on knowledge models 910. Depending on the trading scheme, the consumer may also negotiate 911 with the provider to generate a contract 912.

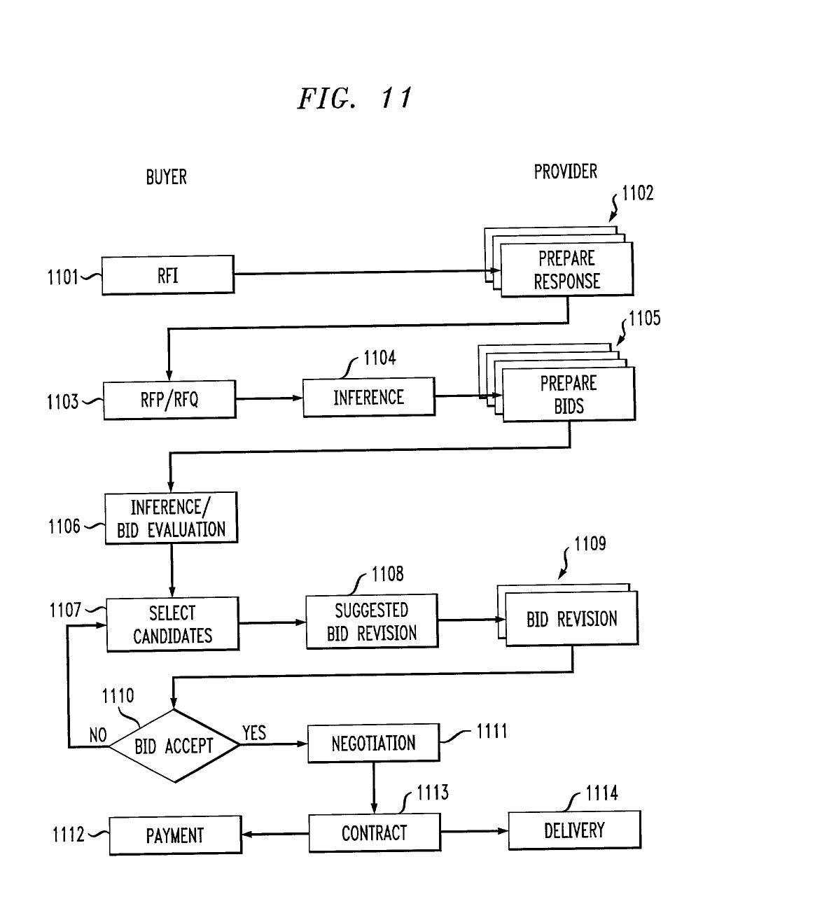

Existing procurement methods are mostly used in two broad categories: Maintenence, Repair, and Operation (MRO) procurement and direct procurement. The former covers items such as office supplies, while the latter involves procuring raw materials. The information goods can also be procured in a similar buy-side private marketplace. The process involved in such situation is illustrated in FIG. 10. In such a case, the buyer first issues a request for information (RFI) 1001 to solicit information. The information providers prepare responses 1002 to the RFI. The information received by the information consumer is then used for defining a request for proposal (RFP) or request for quote (RFQ) 1003. Once the RFP/RFQ is posted, the providers can prepare bids 1004 and submit these to the buyer. The buyer will then evaluate the submitted bids and rank them based on a specific set of criteria in step 1005. The result of the evaluation will be a selected set of candidates 1006, and these candidates will be notified for bid revision 1007. The selected information providers can then revise the bid 1008 and resubmit. The buyer will the re-evaluate the bid (step 1009) and determine whether the bid is acceptable (step 1009). If not acceptable (step 1009=No), the process continues in step 1006; if it is acceptable (step 1009=Yes), the process continues in step 1010. This is repeated until one or more bids are finally acceptable. At that time, the buyer and the provider will negotiate 1010 and define a contract 1011. The contract will specify the payment process 1012 as well as the delivery process 1013. This is a very straightforward way of procuring information goods, and is really not much different from existing procurement methods.

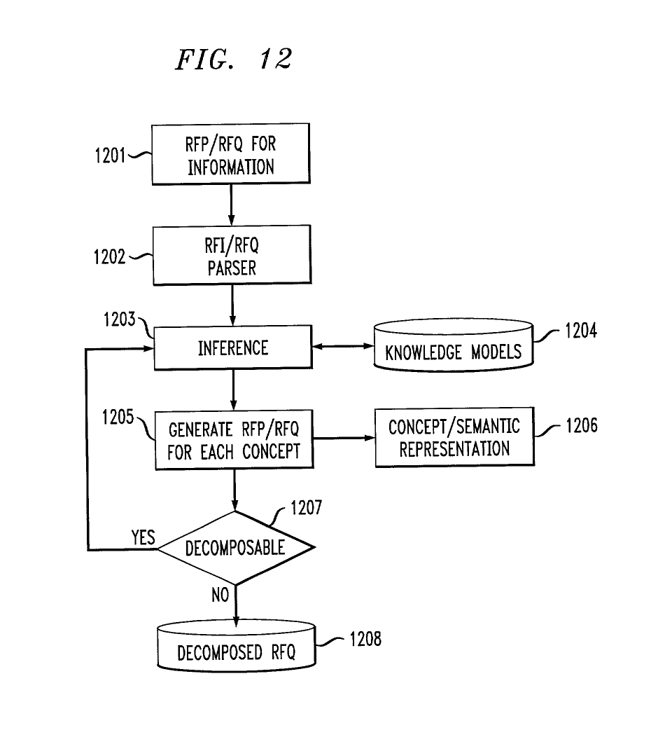

FIG. 11 illustrates the modified process when inference is involved. Similar to the previous case as illustrated in FIG. 10, the buyer first issues a request for information (RFI) 1101 to solicit information. The information providers prepare responses 1102 to the RFI. The information received by the information consumer is then used for defining a request for proposal (RFP) or request for quote (RFQ) 1103. Once the RFP/RFQ is posted, the provider can inference from the RFP/RFQ 1104, prepared bids 1105 based on the inferences 1104, and submit these to the buyer. The buyer will then inference from potentially multiple bids, evaluate the submitted bids, and rank them based on a specific set of criteria. This occurs in step 1106. The result of the evaluation will be a selected set of candidates 1107, and these candidates will be notified for bid revision 1108. The selected information providers can then revise the bids 1109 and resubmit. The buyer will then re-evaluate the bid and determine whether the bid is acceptable in step 1110. This process will be repeated until the bid is finally acceptable (step 1110=Yes). At that time, the buyer and the provider will negotiate 1111 and define a contract 1113. The contract will specify the payment process 1112 as well as the delivery process 1114. A challenge in this scenario is for the seller to inference from the RFP/RFQ in order to determine the strategy for submitting the bid. The bid can address the complete or subset of the requirements on the RFP/RFQ. A challenge also exists for the buyer who may need to inference from the available bids for the intended problem.

FIG. 12 illustrates an exemplary RFP/RFQ parsing process conducted by a provider. Based on the RFP/RFQ for information 1201, the provider first parses the RFI/RFQ 1202 and generates a representation of the RFP/RFQ which is machine-readable. This representation is then used as the source of the inference operation 1203, potentially based on a set of knowledge models 1204. The results of the inference can potentially generate a new set of RFP/RFQ 1205, which is represented as a set of concepts and semantic representation 1206. This inferencing operation is continued (step 1207=Yes) until the concepts or semantics in the RFP/RFQ is no longer decomposable (step 1207=No). The end result of this decomposition process is the production of a set of RFP/RFQ 1208 that was generated through inferencing from the original RFP/RFQ. This is illustrated by Decomposed RFQ 1208. Note that the same process can be conducted by the consumer. In that case, the consumer will publish the decomposed RFP/RFQ directly.

For instance, a consumer might request that a house be built. The consumer will have certain requirements for the house, including price, square footage, number of cars to be put in a garage, and a basic outline for the house. To create a good RFP/RFQ, the producer might use knowledge models 1204 that contain pricing information, layout information, and building materials pricing, quality, and cost to install. The inference step 1203 might create a number of different inferences, such as what the layout of the house should be, the price, how the house should be situated on the lot, and what type of materials should be used on the outside of the house. The house can be decomposed (steps 1207 and 1203), for example, into bathrooms, a kitchen, bedrooms, and a living room. Each of these decomposable elements can have inferences drawn from them. Each room can be further decomposed into fixtures, layout, closets, and more. These will all add to a representation 1206 and to a decomposed RFQ 1208.

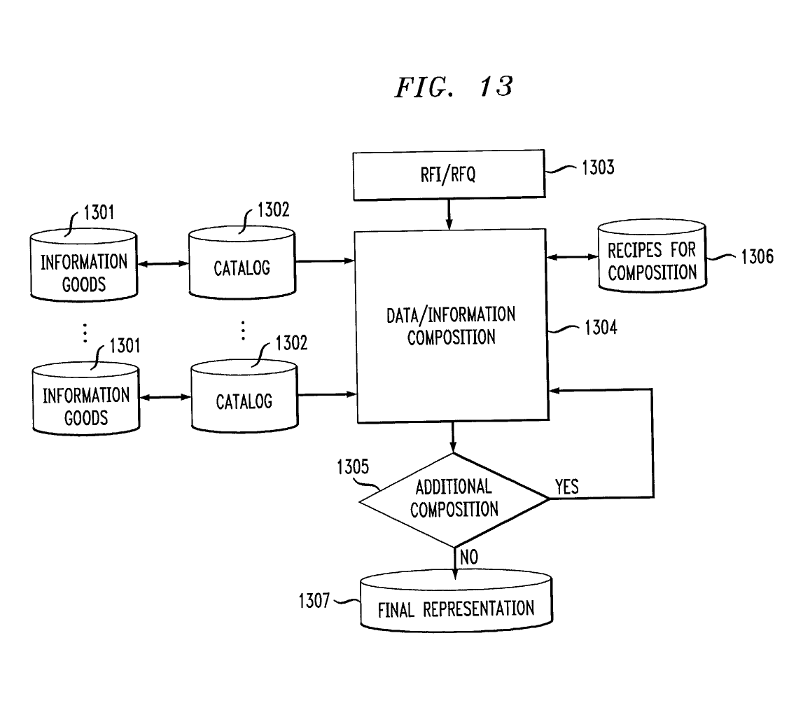

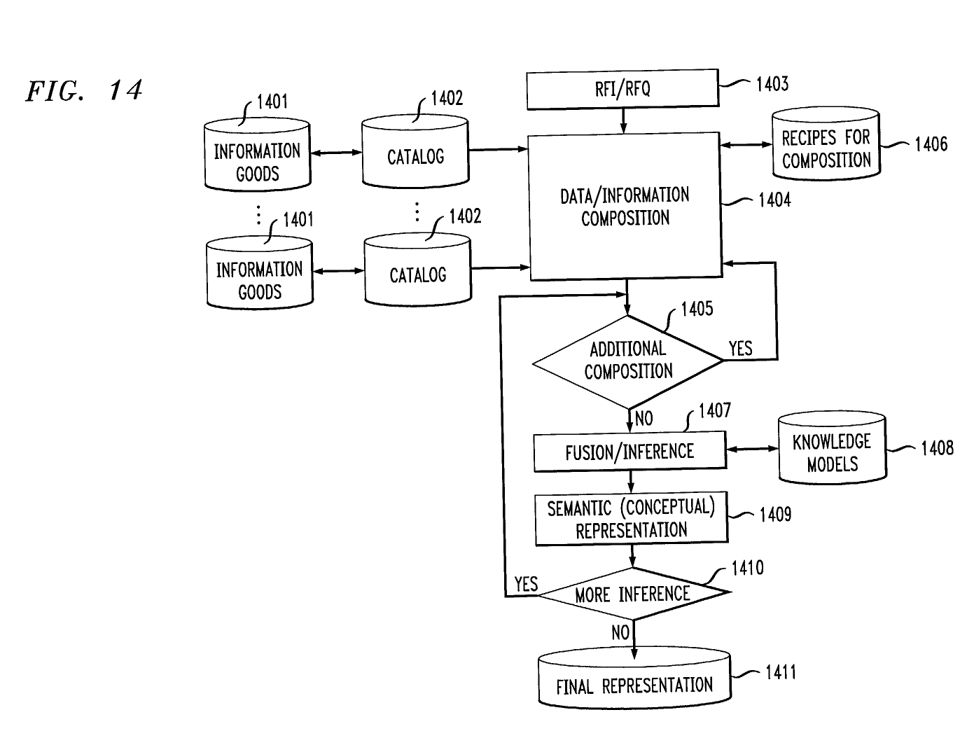

FIGS. 13 and 14 illustrate the roles that can be played by intermediary service providers, as illustrated in FIGS. 1 and 2. FIG. 13 illustrates a process for an intermediary service provider to compose, based on a set of recipes, data or information from multiple data or information providers. In this case, it is assumed that there are a number of providers that provide information goods 1301. Each of the providers has its own catalog 1302. Based on the RFI/RFQ from the consumer, the intermediary service provider can compose data/information 1304 based on an existing methodology or recipe 1306. The composition is recursive through step 1305. The final representation 1308 can then be submitted to the consumer as a bid.

FIG. 14, similar to FIG. 13, illustrates a process for an intermediary service provider to compose, based on a set of recipes, data or information from multiple data or information providers. However, FIG. 14 illustrates a process involving inferencing. In this case, it is assumed that there are a number of providers that provides information goods 1401. Each of the providers has its own catalog 1402. Based on the RFI/RFQ from the consumer, the intermediary service provider can compose data/information 1404 based on an existing methodology or recipe 1406. The composition is recursive through step 1405. The intermediary may also need to perform data/information fusion and inferencing 1407 based on knowledge models 1408 to generate semantic (conceptual) representation 1409. The inference process can also be recursive through step 1410. The final representation 1411 can then be submitted to the consumer as a bid.

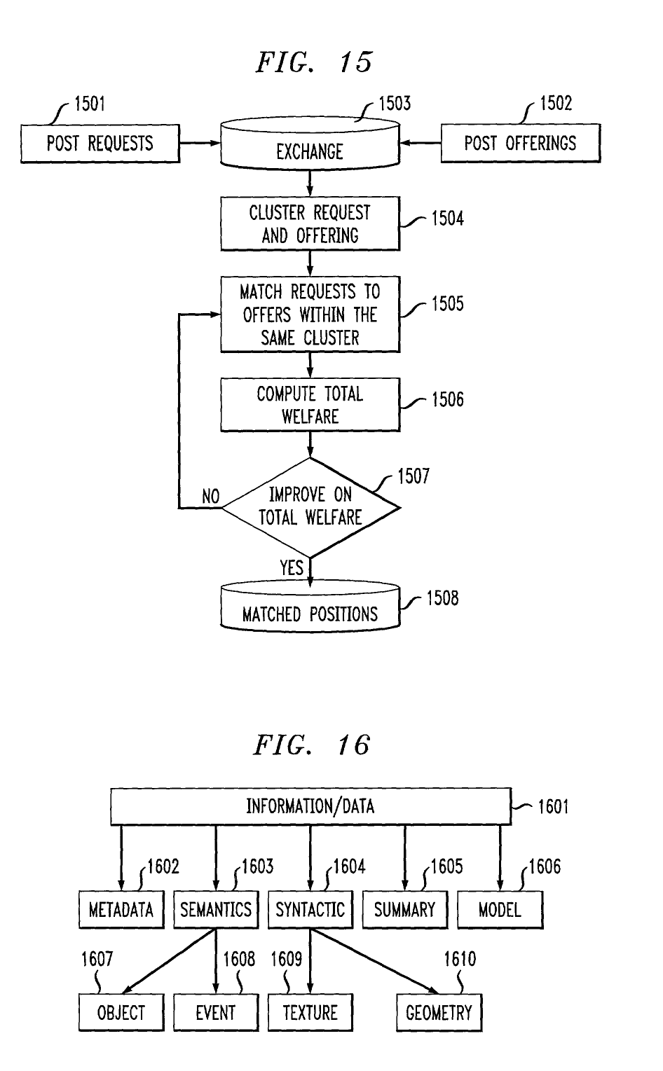

FIG. 15 illustrates a matchmaking process for exchanging information goods. The consumers and providers post the requests 1501 and offerings 1502 of their information goods on the catalog of the exchange 1503. The exchange will cluster the requests and offerings 1504, so that requests and offerings of similar nature will be put into the same category. The requests and offerings are then matched 1505 within the same category (generated by the clustering step 1504). The merit of the matchmaking is evaluated in step 1506 and compared to a previous result. This result is generally zero when the method begins. If the result is not improving (step 1507=No), the process of the matchmaking is repeated. Otherwise (step 1507=Yes), the matched requests and offerings are stored 1508.

In the present invention, a novel annotation approach is used for both requests and offerings of information goods. This approach can utilize eXtensible Markup Language (XML) schema to describe the data models and the concepts embedded in the RFP/RFQs from the consumers of the information goods. As an example, the RFP/RFQ for the risk to a disease outbreak for a given location (x,y) can be annotated using a linear inferencing model:

R(x,y)=0.443X₁+0.222X₂+0.153X₃+0.183X₄,

where X₁, X₂, X₃ correspond to the pixel value of band 4, 5, and 7, respectively, of the Landsat images, while X₄ corresponds to the Digital Elevation Map of that location. This model is described in Glass et al., “Anticipating Risk Areas for Hantavirus Pulmonary Syndrome With Remotely Sensed Data: Re-Examination of the 1993 Outbreak,” Emerging Infectious Diseases, no. 6, 238-247 (2000); Hjelle et al., “Outbreak of Hantavirus Infection in the Four Corners Region of the U.S. in the Wake of the 1997-98 El Niño Southern Oscillation,” Journal of Infectious Diseases, no. 181, 1568-1573 (2000); and Glass, “Spatial Aspects of Epidemiology: The Interface With Medical Geography,” Epidemiologic Reviews, no. 22, 136-139 (2000), the disclosures of which are incorporated herein by reference.

Similarly, the data and information offerings are annotated with the data model, semantics, concepts, and low-level features (such as textures, spectral histogram, shape, etc.) that can be extracted from the data and information offerings. FIG. 16 shows a complete data model. This data model is similar to the conceptual modeling approach developed by the ongoing standard activity, Motion Picture Experts Group (MPEG)-7, for providing a comprehensive annotation infrastructure for multimedia data. This standard is described in Smith et al., “Report of the AHG on Conceptual Modeling,” document M6691, ISO/IEC JTC1/SC29/WG11 MPEG2000 La Baule, FR (November 2000); and Smith et al., “Conceptual Modeling of Audio-Visual Content,” Proc. Int'l. Conf. On Multimedia and Expo (July 2000), the disclosures of which are incorporated herein by reference. In the scheme of the present invention, the objects and events are captured by the semantic annotations while textures and geometry are captured by the syntactic annotations. Due to the potentially large data volume of the information and data offerings, a summary version of the offering can also be provided to facilitate progressive search and retrieval.

FIG. 16 illustrates a data model of annotating information goods such as image/video 1601 for matchmaking. The data model includes the following: metadata 1602, which includes authors, dates, locations, and other information about the images and video that cannot be extracted from the content of the image/video; semantics 1603, which includes objects 1607 and events 1608 that are contained in the image or video; syntactic 1604, which includes the syntactic include texture 1609 and geometry 1610; summary 1605, which specifies the summary of a video, where the summary can be a shortened version or key frames of the videos; model 1606, which captures physics or other models, such as the rotational models of the sun for those sun images captured from the sun. Thus, steps 1602-1610 provide a technique to annotate information goods, such as information/data 1601. Annotations 1602-1610 may be performed automatically, through machine learning or extraction, or may be performed by human interaction, or both. Thus, FIG. 16 illustrates an way to take raw data, such as a satellite image or a video, and provide a tremendous quantity of extra data about the raw data. This extra data helps to match buyers and sellers.

It is recommended to decompose or substitute the requests and offers of the information goods to maximize the available opportunities for matchmaking equivalent data entities and concepts being requested and offered. The substitution process is often based on domain-specific knowledge, such as the spectral bands of 4, 5, 7 of Landsat (i.e., a series of satellites used for acquisition of imagery of the earth from space) can be approximated by the spectral band of 2 from the Advanced Very High Resolution Radiometer (AVHRR) and some of the spectral bands from Moderate Resolution Imaging Spectroradiometer (MODIS) on Terra (formerly, EOS AM-1, which is a satellite Earth Observing System). Consequently, alternative data sources can be applied to the disease outbreak model from the previous subsection when the data from Landsat is unavailable, for example, due to cloud cover. The decomposition process is often based on inference models, such as the Bayesian Network model. Bayesian networks can readily handle incomplete data sets, allow one to learn about causal relationships, and can be used in conjunction with Bayesian statistical techniques to facilitate combing domain knowledge and data.

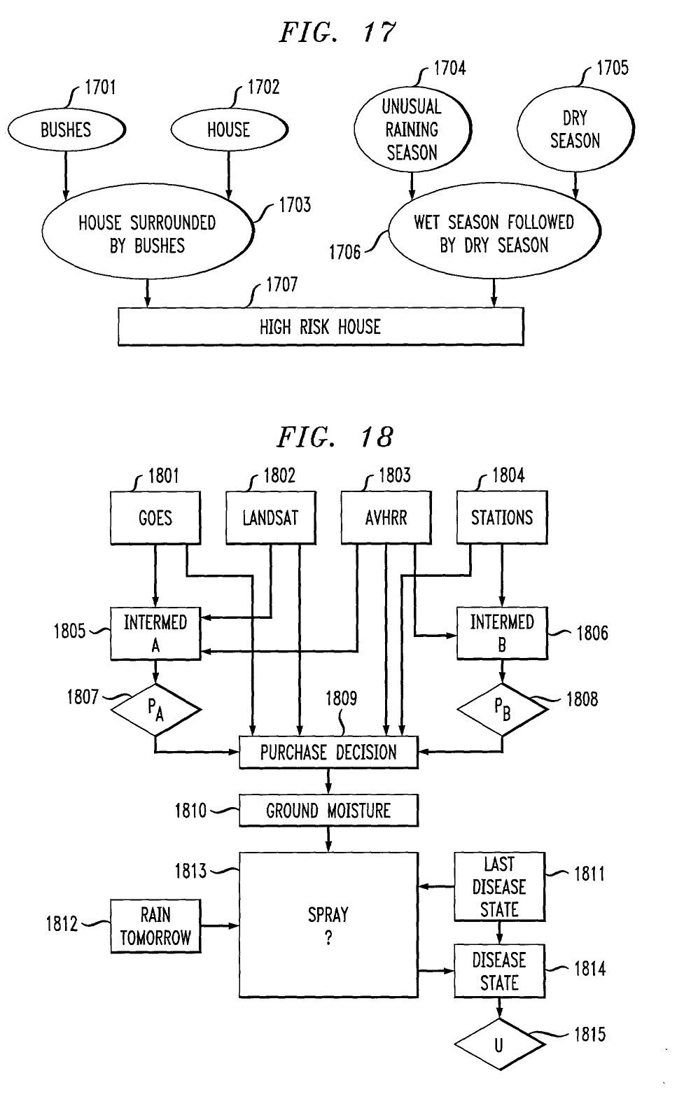

Recently, methods have been developed to learn Bayesian networks from data. As an example, shown in FIG. 17, the high-risk houses that are vulnerable to Hantavirus Pulmonary Syndrome (HPS) comprise the following rules: (1) area of houses, which are (2) surrounded by bushes, and have (3) a weather pattern of a rainy season followed by a dry season. Consequently, a request for locations that are vulnerable to HPS disease outbreak can be decomposed into attributes that contribute the evaluations of the risk model associated with this disease, namely, the spatial texture (from satellite images) and the weather pattern (potentially from GOES 1801, which is a Goddard Earth Observing System, data series and weather stations).

FIG. 17 shows the Bayesian model for inferencing a high-risk house 1707 that is vulnerable to Hantavirus Pulmonary Disease. This disease is usually carried by rodents such as mice, and the population of the mice is modulated by the environment, such as those houses surrounded by bushes 1703, as well as the weather such as wet season followed by dry season 1706. House surrounded by bushes can certainly be inferred from the existence of bushes 1701 and a house 1702. The weather pattern wet season followed by dry season is determined by the unusual raining season 1704 followed by the dry season 1705. This inference model can then be used to determine how to procure data or information that can be used to derive the risk of a certain house.

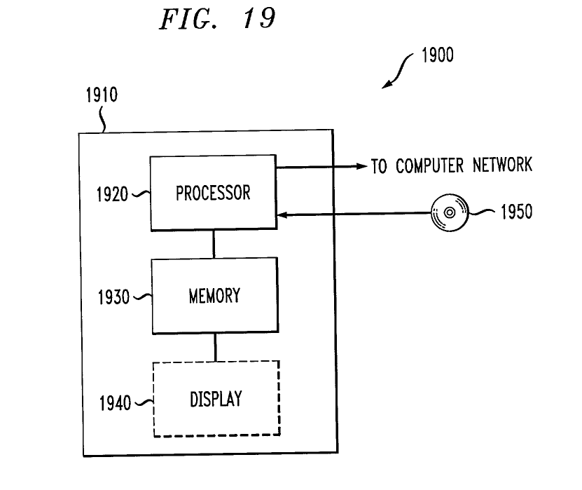

Consider another situation, where a Westchester County agency of New York state is deciding on whether to spray for disease-carrying mosquitoes and where to concentrate their spraying activity. This is illustrated in FIG. 18. There is a limited budget, so spraying has to be done with the expectation of greatest return for the investment. There are several considerations in the decision (step 1813) to spray. The current state of the disease spread 1814 is one consideration. Another consideration is the amount of current 1810 and expected ground moisture 1812 present. Other factors may also play a role, such as the ground temperature. The spray is more effective if the ground is dry and if there is no rainfall following the spraying. The final social utility depends on the overall disease state and the utility 1815 is to be maximized. The final diamond node (utility 1815) in FIG. 18 represents this utility.

Information about the state of the moisture in the ground can be inferred from several sources of information. There are fixed-cost sources of information. For example, satellite information can be purchased at fixed rates from GOES 1801, Landsat 1802, AVHRR 1803, and Terra (formerly EOS AM-1; not shown in FIG. 18). These sources vary in their prices, their resolution and their timeliness. For example, a company called Space Imaging (Thornton, Colo.) lists three general levels of resolution—high, medium and low—with each level further delineated based on finer grades of the resolution level and whether the image information is panchromatic (a black and white image with high visual sharpness), multispectral (containing colors from many bands, such as infrared, which provide different degrees and types of interpretations about features) or combinations thereof.

There are also profit maximizing information providers who provide information through dynamic, competitive markets. These information providers are shown as Intermed A 1805 and Intermed B 1806 in FIG. 18. These providers may, in turn, purchase and add value to other sources of information. That is, they may form a web of purchases to determine the needed information. For example, Space Imaging, discussed above, offers custom services and works with a network of re-sellers that provide value-added expertise. They may produce this information on a demand only basis or routinely. In any case, pricing is critical and must meet competitive pressures. FIG. 18 shows that each profit maximizing provider must determine a price for their product (the diamond shaped nodes 1807 and 1808). Finally, various stations 1804 located throughout the county can provide measurements of ground moisture and/or recent rainfall amounts. This “ground-truth” 1804 can be used in conjunction with satellite data to form a broader, more precise picture of the moisture state.

Westchester County needs to make a decision 1813 whether to spray (i.e., whether or not to spray for mosquitoes and to pay for this), and this decision 1813 is also based on the ground moisture 1801, the rain tomorrow 182, the current disease state 1811, the utility 1815, and pricing information and decisions 1809. The consumer, i.e., Westchester County, therefore usually wants to minimize price (illustratively, step 1809) while maximizing utility 1815. On the other hand, the producers 1801-1806 generally want to maximize price (such as prices 1807 and 1808) while minimizing the amount of information goods for the price.

In the following discussion, a dynamic pricing method is disclosed for solving a problem of dynamically determining competitive prices of information goods. The Internet provides a platform where consumers can spell-out their information needs and have providers create a possible web of relationships to competitively meet these consumer needs. These webs will be referred to as a “food chain” of information providers. Methods will be examined to determine competitive prices where time constraints, the short shelf-time of information goods, and the uncertainty of the information are all factors of concern.

There are many considerations that affect competition, some of which are the following: Do the firms produce exact substitute goods or are they differentiated?; “Is the competition a single shot or a multi-period encounter?”; “Do firms decide on production volumes, prices, or what?”; “Is there one customer or many?”; “Are they similar or different?”; “Is knowledge about the market perfect or imperfect, symmetric or asymmetric?”.

It is assumed that consumers are fully informed of producer prices since they go through an RFQ/RFP process. Consider the cases where first line producers know consumer utilities and when they only have distributional information about consumers. Also, assume consumers act as if maximizing expected utility. Different consumers may have different utilities. Realizing that consumers might have different preferences, a monopoly might be able to devise a method to price-discriminate and thereby possibly sell to more consumers. Price discrimination generally can be divided into the following areas: first degree price discrimination, which is the best possible scheme, and is where the producer prices the good for each consumer at the maximum amount the consumer is willing to pay; second degree price discrimination, which uses nonlinear pricing (like volume discounts); and third degree discrimination, which uses legal groupings of consumers to base prices (like student discounts).

Without a priori knowledge of the distribution of consumer utilities, economist often make simplifying assumptions. Most cases reduce to some sort of assumption regarding the overall distribution of utilities. For example, the highest price a consumer would be willing to pay for a good (the reservation price) may be assumed to be uniformly distributed over some price range or the reservation price may be a function of the distance between a producer and consumer within some market topology. For instance, this could be along a line segment, as in the Hotelling model, or within a circle as in the Salop model. The Hotelling model is described in Hotelling, “Stability in Competition,” Economic Journal, 39, 41-57 (March 1929), while the Salop model is described in Salop, “Monopolistic Competition with Outside Goods,” Bell Journal of Economics, 10, 141-156 (1979), the disclosures of which are incorporated herein by reference. Another approach is to use price-discovery mechanisms such as negotiation or auctions.

A food chain marketplace may be considered as an oligopoly, which is a market with a few suppliers of relevant information and many consumers that are price-takers. As the chain gets closer to an end consumer, the desired product attributes become more specific. Higher up the food chain, demand becomes more aggregate and uniform.

There are many normative models of competition that might apply. For instance, competition models that might apply are described in Baye, “Managerial Economics & Business Strategy” (1999); and Varian, “Microeconomic Analysis” (1992), the disclosures of which are incorporated herein by reference. A Sweezy oligopoly has firms producing somewhat differentiated products with barriers to entry and an asymmetric, pessimistic response to price changes (i.e., lowering prices produces a similar response from competitors while increasing prices do not result in similar responses). A Cournot oligopoly has firms producing identical or differentiated products with barriers to entry where each firm determines the amount of fixed output. A Stackelberg oligopoly has firms producing identical or differentiated products with barriers to entry where one firm (the leader) announces production quantities that maximize its profits and the others then act as in a Cournot oligopoly. A Bertrand oligopoly has firms competing on price alone where firms reacts optimally to price changes by competitors, has firms producing identical products at a constant marginal price, has barriers to entry, has no transactions costs, treats consumers as perfectly informed, and assumes any firm can produce all the output needed by consumers. For the exemplary “food chain” setting, the production volume models (Cournot and Stackelberg) are generally not relevant. The Sweezy and Bertrand oligopolies better fit the situation. However, the Bertrand model usually requires identical products. This may force a result that yields a winner-take-all situation and has been often called a monopolistic competition. A slightly generalized form of the Bertrand model allows for differentiated products, so the distinction between these latter two types of oligopolies reduces to their pricing strategies. In the remainder of this discussion, a Bertrand-type oligopoly with differentiated products will be used.

One key issue to resolve is whether the producer and consumer decisions are one period or repeated over time. Since it can be imaged that consumers are going through an RFQ/RFP process, one can assume that their decisions are one-period decisions. Situations involving similar decisions over time or contracts covering multiple periods are not considered herein, but those skilled in the art can adjust the pricing models disclosed herein to take multiple periods into account.

Competitive pricing models usually require a mapping of who knows what and what is important to each decision. The complex interaction of decisions, information, and utilities in this exemplary food chain economy will be represented as an influence diagram. Influence diagrams are described in more detail in Goldstein, “Adjusting Belief Structures,” Journal of the Royal Statistical Society, Series B, 50, 133-154 (1998), the disclosure of which is incorporated herein by reference.

An influence diagram, such as the one shown in FIG. 18, is itself a Bayesian network modified to include decision making. This is discussed in Howard et al., “Influence Diagram,” in The Principles and Applications of Decision Analysis 2 (1981), the disclosure of which is incorporated herein by reference. An influence diagram is a temporally oriented, directed acyclic graph (dag). There are three types of nodes. The chance nodes represent chance variables (shown as rounded-rectangles); the decision nodes represent decision variables (shown as rectangles); the value nodes represent prices or utilities (shown as diamonds).

In general, when decisions are spread throughout the network, there is an issue on how to represent utilities and take expected values. Some methods use additive utilities and others multiplicative ones. A generalization of influence diagrams that attempts to simultaneously modularize utilities and probabilities is termed Expected Utility Networks. This is discussed in Mura et al., “Expected Utility Networks,” Proc. of the Conference on Uncertainty in Artificial Intelligence, San Francisco, Calif. (1999), the disclosure of which is incorporated herein by reference. Fortunately, one can avoid many related problems if the decision nodes are naturally ordered so that all producer decisions are made before consumer decisions. This is the case in FIG. 18.

In FIG. 18, there are three types of directed arcs. An arc into a value node represents a functional dependency. An arc into chance nodes represents a probabilistic dependency. Finally, an arc into a decision node means that the state of all the parent nodes is known before the decision is to be made.

The state space of a chance or decision variable, X, is signified by S_{X} and contains the set of possible outcomes (for a chance variable) or decisions (for a decision variable). The set of immediate predecessors of a chance variable, C, is denoted by pred(C). The conditional probability of C given pred(C) is denoted by P(C|pred(C)).

D₁ is the ith decision variable and the set of all decisions is D={D₁, . . . , Dₙ}. Decisions labeled from 1 to n−1 are producer decisions where the remaining final consumer decision is the target consumer. Corresponding to these decision points are sets, Iᵢ. The ith information set contains chance variables observed before making decision Dᵢ₊₁. It is assumed that there is no forgetting of previously observed values. The set of all chance variables is C=∪ᵢ₌₀ⁿIᵢ. For convenience, the set of variables known before making decision Dᵢ is denoted as pred(Dᵢ).

In normal Bayesian updating, a problem occurs when there are undirected cycles (i.e., cycles occurring when one replaces the directed arcs with undirected arcs.) The problem reduces to “double-counting” evidence. To correct this, various procedures have been developed, such as clustering, conditioning or stochastic simulation. This is discussed in Pearl, “Probabilistic Reasoning in Intelligent Systems,” 2nd Ed. (1988), the disclosure of which is incorporated herein by reference. For example, in clustering, a process is used to aggregate variables to form a junction (also called a “join”) tree and then a triangulation is employed to fill in links that make the tree “chordal.” Triangulation is described in Draper, “Clustering Without (Thinking About) Triangulation,” Proc. of the Conf. on Uncertainty in Artificial Intelligence, San Francisco, Calif., 125-133 (1995); making the tree “chordal” is discussed in Jensen et al., “Optimal Junction Trees,” Proceedings Uncertainty in Artificial Intelligence (UAI), Seattle, Wash., 360-366 (1994), the disclosures of which are incorporated herein by reference. Other methods have been proposed, for example see Draper, pp. 125-133. When loops are present, inference becomes intractable (it is NP hard, which is shown in Jensen).

In a Food Chain economy, it is reasonable to expect that loops will naturally arise since intermediaries are likely to draw on similar sources of information. For example, in FIG. 18, AVHRR is involved in several loops. This issue is addressed below.

Traditional Bayesian Updating

In traditional Influence Diagrams, Bayes law is used to produce posterior distributions used throughout an inference:

$$P ( C \vert pred ( C ) ) = \frac{P ( pred ( C ) \vert C ) P ( C )}{P ( pred ( C ) )}$$

A criticism often leveled against the use of influence diagrams (and Bayesian networks in general) is that too much information must be specified and the resulting computational burden is impractical—that is the specifications of pred(C). For a criticism along these lines, see Goldstein, the disclosure of which has already been incorporated herein by reference.

Bayes Linear Method

A new approach has been gaining interest in situations where it is hard to provide such specification depth about distributions and where the computational demands of Bayes law are too burdensome. See Goldstein, the disclosure of which has already been incorporated herein by reference. Termed Bayes Linear Method, only means, variances and covariances need be specified. This methodology is considered an approximation to a fall Bayesian approach but is exact in certain situations. Again, see Goldstein, the disclosure of which has already been incorporated herein by reference.

(1) Linear Bayes Updating with No Decisions

The adjusted expectation of a chance variable, C, given that T=pred(C) has been seen, is given by

E(C|T)=E(C)+Cov(C,T)Var(T)⁻¹(T−E(T))

Here E(C) is the expected value of C before seeing T, Var(T) is the usual variance-covariance matrix of pred(C) with Var(T)⁻¹ as its (generalized) inverse. The Variance matrix might easily be singular if there are perfectly correlated information sources. In such cases, one can remove such sources or just use the Moore-Penrose generalized inverse. The Cov(C,T) is the covariance matrix of C with pred(C). These values are pre-posterior values. Once T is observed, posterior values may be determined. Similarly, the adjusted variance of C is given by

Var(C|T)=Var(C)−Cov(C,T)Var(T)⁻¹Cov(T,C)

These relationships are not dissimilar from Bayesian updates with Gaussian distributions.

Referring to FIG. 18, for information that might be purchased when deciding what to buy in making a ground moisture level inference, the following are loosely specified. There are six possible suppliers of information (1801 through 1806) about the ground moisture content. Let C represent the actual ground moisture content and T the vector of ground moisture content that each of the six information providers 1801 through 1806 supplies. Note that a discussion of the decision on which information should be purchased is postponed until later.

The following is an example. Suppose there are the following subjective beliefs and reasonable resulting specifications:

Best to worst moisture estimates are found from the following (best has the lowest number): (1) Intermediary B 1806; (2) Intermediary A 1805; (3) Local Ground stations 1804; (4) AVURR satellite data 1803; (5) Landsat data 1802; and (6) GOES data 1801.

Their variances, and their covariance with the actual ground moisture 1810, are arranged, as shown below, with increasing values consistent with these beliefs.

$$Var ( T ) = ( \begin{matrix}1 & & & & & \\ & 1.5 & & & & \\ & & 2 & & & \\ & & & 4 & & \\ & & & & 6 & \\ & & & & & 10\end{matrix} )$$

$$Cov ( C , T ) = ( \begin{matrix}0.3 & 0.4 & 0.6 & 1 & 1.5 & 2\end{matrix} )$$

Intermediary A 1805 and B 1806 have fairly independent estimates generally except both are positively correlated to varying low degrees with AVHRR 1803 results. Landsat 1802 estimates are often mildly, negatively correlated with the results of Intermediary A 1805. The remaining correlations are higher (usually at the 0.5 correlation level). These beliefs give the following:

$$Var ( T ) = ( \begin{matrix}1 & & & 0.2 & & \\ & 1.5 & & 0.49 & - 0.9 & \\ & & 2 & 1.41 & 1.73 & 2.24 \\ 0.2 & 0.49 & 1.41 & 4 & 2.45 & 3.16 \\ & & - .9 & 1.73 & 6 & 3.87 \\ & & 2.24 & 3.16 & 3.87 & 10\end{matrix} )$$

$$Cov ( C , T ) = ( \begin{matrix}0.3 & 0.4 & 0.6 & 1 & 1.5 & 2\end{matrix} )$$

It has been relatively dry recently with only a couple of recent mild rainfalls. Based on this, the moisture level is suspected to be around 30 units with a variance of 5.

E(C)=30, Var(C)=5

In an effort to get some value from old data, the groups publish their previous data free as a marketing ploy. The most recently published values are:

E(T)′=(30, 28, 33, 25,33, 36)

Based on these specifications, one can infer the following. Suppose one buys all six sources and they report [T]=(28,27,32,24,31,34), then one would update the beliefs to get:

E(C|T)=E(C)+Cov(C,T)Var(T)⁻¹(T−E(T))=28.20

Var(C|T)=Var(C)−Cov(C,T)Var(T)⁻¹Cov(T,C)=4.15

(2) Updating with Decisions

When decisions are involved with choosing sources of information, the update problem simplifies to including just those chosen sources. Let x be a zero-one vector expressing our mix of chosen data sources. Let I be the identity matrix and be a diagonal matrix whose diagonal consists of the components of x. Again, let T=pred(C) to simplify notation. The update formulas become:

E(C|T)=E(C)+Cov(C,T)dₓ(dₓVar(T)dₓ+I−dₓ)⁻¹dₓ(T−E(T))

Var(C|T)=Var(C)−Cov(C,T)dₓ(dₓVar(T)dₓ+I−dₓ)⁻¹dₓCov(T,C)

(3) Undirected Cycles

Although undirected cycles pose a problem for inference processes in normal Bayesian models, Bayes linear models are relatively immune to the problem. The reason is that the covariances reflect mutual information, thus automatically preventing double counting. Of course, then, the burden shifts to the specification of covariances. To illustrate, consider the following case. Assume both intermediary A 1805 and B 1806 provide the same information. Suppose that the following occurs:

$$Var ( T ) = ( \begin{matrix}2 & 2 \\ 2 & 2\end{matrix} )$$

$$Cov ( C , T ) = ( .5 , .5 )$$

Notice that the variances must be the same and that the covariance of T must be equal to the variance since the two sources are perfectly correlated. Finally, the covariance of each source with the chance variable C must be the same. Notice too that any valid, non-zero choice for x in

Cov(C,T)dₓ(dₓVar(T)dₓ+I−dₓ)⁻¹dₓCov(T,C)

gives the same adjustment. There is no double counting (even when both sources are chosen).

In the following description, a method is disclosed for determining the optimality conditions for competitive pricing in a Linear Bayes influence diagram.

Expected Utility Maximization

In this exemplary “Food Chain” economy, it is imagined that consumers make decisions Dₙ to maximize their expected utility. The expected utility is taken as the well-known mean-variance model given by

aE(C)−p−λVar(C)

where E(C) is the expected value of the outcome sought, a provides a scaling so that p, the total price of any purchased information, can be supplied in dollars, λ expresses the cost of uncertainty in C where Var(C) is the uncertainty, as measured by the variance about the true state of C. This expected utility function is exactly valid if the utility function is quadratic (which has problems since it is decreasing over some range) or the random variables are multi-normally distributed. In cases where this latter assumption is approximately correct, the results herein are reasonable approximations. However, there are objections to the mean-variance model, which are explained in Liu, “Approximate Portfolio Analysis,” European Journal of Operational Research, 119, 35-49 (1999), the disclosure of which is incorporated herein by reference. As Liu remarks, the “popularity of the mean-variance model is not because of its precision of approximating the [von Neumann-Morgenstern] theory but because of its simplicity and the power of its implication as evidenced by the capital asset pricing model.” The coarse utility functions described by Liu might provide another fruitful avenue for investigation. Notice, a higher priced item may have a higher utility if it provides more accurate estimates.

Let T represent the prior information on I₀ from the two suppliers and x the zero-one vector representing a decision D₁. Assume the following prior beliefs:

E(T)′=(1 1 8) E(GroundMoisture)=10 Var(GroundMoisture)=4 Cov(Ground Moisture,T)=(0.4 0.2)

$$Var ( T ) = ( \begin{matrix}1 & - 1 \\ - 1 & 2\end{matrix} )$$

From the linear Bayes updating rules, the following result:

E(Ground Moisture|x)=10+x₁(0.4T₁−4.4)+x₂(0.1T₂−0.8)+x₁x₂(0.6T₁+0.5T₂−10.6) Var(Ground Moisture|x)=4−0.16x₁−0.02x₂−0.34x₁x₂

with cost

p₁(D₁)=ax₁+bx₂

The expected utility is then

EU=a[10+x₁(0.4T₁−4.4)+x₂(0.1T₂−0.8)+x₁x₂(0.6T₁+0.5T₂−10.6)]−ax₁−bx₂−λ(4−0.16x₁−0.02x₂−0.34x₁x₂)

This gives a pre-posterior estimate of expected utility. The primary interest is in the trade-off of uncertainty against the cost of information. To determine the value of information, one needs to take an expectation over T and maximize. For example, assume T=E(T), with λ=2, a=0.5, and b=0.2. Solving

min{0.5x₁+0.2x₂+2(4−0.16x₁−0.02x₂−0.34x₁x₂)}

gives x*₁=x*₂=1 with a net benefit of 8−7.66=0.34 over not purchasing any information. Purchasing only source A gives a net of −0.18 and B a net of −0.16. The negative correlation between these two sources provides a reduction in uncertainty greater than the cost of the information.

In general, one could take an expected value of the objective function to account for the unknown final values, T. Rearranging the problem for the consumer, then, results in

am+λv+maxₓ{ax′Mx+λx′Vx−p′x}.

For example, for any symmetric distribution over T centered at E(T), the above problem reduces to

$$10 α - 4 λ + max \{ λ {x}^{′} ( \begin{matrix}0.16 & 0.17 \\ 0.17 & 0.02\end{matrix} ) x - {p}^{′} x \}$$

Firms are viewed as providing products differentiated only on the accuracy of the information and price. Other factors, such as timeliness, are reflected in these measures. When attempting to maximize the utility function of a consumer, one can start by assuming that there is only one customer and one level of information providers for that consumer and one period. This may be generalized later. One may also start with duopolies, which provide a feel for the issues, and present full generalizations later. Refer to FIG. 18, and suppose that the information sources 1801 through 1806 must set competitive prices. First, a review of the Nash equilibrium and Bertrand duopoly are given before proceeding with the analysis.

The following is a description of the Nash Equilibrium, which is named after the Nobel Laureate John Nash. If there is a set of strategies with the property that no player can benefit by changing her strategy while the other players keep their strategies unchanged, then that set of strategies and the corresponding payoffs constitute the Nash Equilibrium. The basic assumptions for Nash equilibrium are the following: each person or firm is acting rationally; no one believes his actions will change other decisions; and no one has an incentive to change.

Suppose two companies or two individuals are bidding on a project. The winner (with lower bidding price) will get the whole project, and this is so called Bertrand Duopoly. And the Nash equilibrium price is zero (if the marginal cost is zero).

By way of review, the classic Bertrand duopoly has a simple Nash equilibrium. With perfect substitution, a consumer purchases from the lowest priced producer. Let cᵢ be producer i's fixed costs if they produce the good (we assume a zero marginal cost for information goods). So the consumer solves

max{−p₁x₁−p₂x₂}

and each producer solves

max{pᵢ} such that pᵢ≧cᵢ,pᵢ≦p₁₋ᵢ,i=0,1

giving a solution of

x₀=1,x₁=0,p₀=c₁−ε if c₀<c₁

x₀=0,x₁=1,p₁=c₀−ε if c₀>c₁

x₀ε{0,1},x₁=1−x₀,p₀=p₁=c₀ if c₀=c₁

When goods are not perfect substitutes, the Nash equilibrium is more involved as evidenced below.

Single Customer, One Level of Producers (Buy-side marketplace)

In the exemplary Food Chain economy with a duopoly, the consumer must solve

am+λv+maxₓ{ax′Mx+λx′Vx−p′x}

or, simplified,

maxₓ{x′Ax−p′x}

where

A=aM+λV

and each producer solves

max{pᵢ}s.t.pᵢ≧cᵢ,xᵢ(p)=1

where xᵢ(p) is a decision price of the consumer, given prices, p. If there is no solution, pᵢ=cᵢ. This problem is complicated by the fact that the consumer may find buying both information goods to be expected-value maximizing. A few examples will illustrate the various possibilities.

a) Duopoly Solutions

$$\text{Example 1:} A = ( \begin{matrix}a & 0 \\ 0 & a\end{matrix} ) \text{and} c = ( \begin{matrix}u \\ u + w\end{matrix} )$$

where all values are positive. This case somewhat mimics the classic Bertrand model. The first producer can always guarantee the purchase of his product (since he has a lower production cost) at a maximum price (provided a>u ) by choosing the following prices (a zero price implies no production).

p₀=aδ(a≧u)

p₁=aδ(a≧u+w)

Interestingly, when a≧u+w, it is advantageous to the consumer to purchase both sources of information at price a. This is a departure from the normal Bertrand solution.

$$\text{Example 2:} A = ( \begin{matrix}a & 0 \\ 0 & b\end{matrix} ) \text{and} c = ( \begin{matrix}u \\ u + w\end{matrix} )$$

where all terms are positive. Depending on these values, the lowest-cost producer may not be able to assure a sale, even though he has the lower production cost. The Nash equilibrium for this case is as follows.

p₀=aδ(a≧u)

p₁=bδ(b≧u+w)

$$\text{Example 3:} A = ( \begin{matrix}a & η \\ η & b\end{matrix} ) \text{and} c = ( \begin{matrix}u \\ u + w\end{matrix} )$$

where η may be positive or negative and all other terms are positive. When η>0, it is possible that, while purchasing a single item is never attractive, purchasing both may be worthwhile. Conversely, when η<0 there is a disincentive to purchase both items and competition will force prices down. The Nash equilibrium for this case is as follows.

$${p}_{0} = \{ \begin{matrix}( a + η ) δ ( a + η \geq u ) η \geq 0 \\ u δ ( a \geq u ) η < 0\end{matrix} \\ {p}_{1} = \{ \begin{matrix}( b + η ) δ ( b + η \geq u + w ) η \geq 0 \\ ( u + w ) δ ( b \geq u + w ) η < 0\end{matrix}$$

In all cases for a duopoly, the optimal Nash prices are independent of the prices of the competitor, in the sense that the prices are not functionally dependent on each other. Instead, the prices depend only on problem data.

b) Oligopoly Solution

Generalizing to more than two producers complicates these simple price structures, as would be expected. The general consumer problem is

maxₓ{aE(C|x)−p′x−λV(C|x)}

where x is a zero-one vector, C is the chance vector of interest, and p is determined by the producers. Solving the pre-posterior version, assuming the first term drops after taking expectations, yields a simpler form through the following steps.

maxₓ{aE(C|x)−p′x−λV(C|x)}

=aE(C)−λV(C)+maxₓ{aCov(C,T)dₓ(dₓVar(T)dₓ+I−dₓ)⁻¹dₓE(T−E(T))+

λCov(C,T)dₓ(dₓVar(T)dₓ+I−dₓ)⁻¹dₓCov(T,C)−p′x}

=aE(C)−λV(C)+maxₓ{λCov(C,T)dₓ(dₓVar(T)dₓ+I−dₓ)⁻¹dₓCov(T,C)−p′x}

Let

γₓ≡dₓ(dₓVar(T)dₓ+I−dₓ)⁻¹dₓCov(T,C)

To determine x, the consumer solves

maxₓ{λγₓCov(T,C)−p′x}

Each producer solves

max{pᵢ} such that pᵢ≧cᵢ,xᵢ(p)=1

where pᵢ is the decision of the consumer, given prices, p. If there is no solution, pᵢ=cᵢ. Here it is being assumed that the cost to the producer is unique to this information request by the customer.

The following is a theorem (entitled Theorem 1). This theorem proves the correctness of the Nash procedure related above. Theorem 1: The Nash algorithm produces a Nash equilibrium. Proof: If X={0} after the initialization, no increase in prices can improve the utility of the consumer and the producers cannot lower their costs, so this is an equilibrium solution.

Partition X into n≧1 subsets, Xᵢ, where tⁱ=Λ_{xεX}_{ᵢ}x≠0 and tⁱΛt^{j}. These can be considered coalitions in game-theory parlance. If n=1, then the core producers, represented by the non-zero components of (i.e., t¹), can increase their prices without reprisal by any other producer. Otherwise, all coalitions are blocked from increasing their prices and we have a Nash equilibrium. Since the utility of the consumer is linear in p, all core producers must increase their prices by the same amount. If not, and no more increase is possible, the producer shorted could increase his price and ruin the dominance of the coalition.

The core can increase their prices until some other coalition can block the core (meaning they will provide a better expected utility). Necessarily, such a coalition must not contain all members of the core. Y=arg_{t′x<l′t}max{aE(C|x)−p′x−λV(C|x)} provides potential blocking coalitions.

If D={γεY:t≧y} is non-empty, then the current core is actually blocked by a subset represented by r=t−Λ_{yεD}y and this replaces the core. In either case, the core producers prices are increased uniformly until the expected utility of the consumer drops to z_{y}=max_{t′x<l′t}aE(C|x)−p′x−λV(C|x). This ends the proof.

Fixed Price Producers

Fixed priced-producers do not complicate the determination of Nash prices directly (since their prices are fixed). But they do impact the decision of the consumer. The Nash algorithm is slightly modified in a natural way to handle these producers. Let q be a zero-one vector having zero components for fixed-priced producers. The only change to algorithm Nash is replacing the definition of t by:

t=qΛ(ΛxεXx).

Zero Fixed-Costs

If the producers all have zero fixed costs, then the problem simplifies. Suppose x solves the consumer problem for a given λ>0 and p≧0. If x solves

maxₓ{λγₓCov(T,C)−p′x}

then x also solves

maxₓ{βλγₓCov(T,C)−βp′x}

for any β>0 meaning it solves the consumer problem for a consumer with βλ and producer prices βp. If p is optimal for λ, then βp is optimal for βλ. Thus optimal Nash prices and maximal expected utility are all linear in λ. These observations are summarized in the following theorem.

Theorem 1.2, Zero Fixed Costs. If all producers have a zero fixed cost of production, the Nash equilibrium prices and maximal expected utility are linear in λ. Hence, for zero fixed costs, the problem is solved once for any positive λ, and then one can simply compute optimal prices for any other λ.

Multiple Customers, One Level of Producers

Whenever multiple customers are involved, price discrimination becomes an issue. In an RFQ/RFP setting, it may be possible to exact first-degree price discrimination and charge Nash prices as determined above. This is because the negotiation process might enable producers to determine the a and λ of the consumer through standard estimation procedures to assess risk-aversion.

Without price discrimination, each producer determines a strategy to segment their market. They may segment based on price, or product quality (versions), or some other creative scheme. A full game-theoretic analysis is required and mixed-strategies are a likely outcome.

If it is assumed that each producer will post only one price, offering only one generic product (i.e., he does not version his offerings), a slightly more tractable problem results. Suppose a and λ are not observable but that they are distributed over the population of N consumers according to a probability mass function ƒ(a,λ). Furthermore, assume (as is often the case) that a does not affect consumer choices and ƒ(λ) is the marginal mass function obtained from ƒ(a,λ). Let X*(p|λ) be the set of optimal solutions for a consumer with utility characterized by λ given prices p. Then the expected profit to producer i is:

$${p}_{i} {\sum }_{λ} Nf ( λ ) {\sum }_{x ∈ X * ( p \vert λ )} \frac{{x}_{i}}{\vert X * ( p \vert λ ) \vert} - {c}_{i}$$

Unlike the earlier case with perfect price discrimination, it may be profitable to charge a price lower than the production costs because the one-time fixed costs is spread over more customers. In the limit, the fixed cost is not relevant. Thus, when ƒ(λλ) is a density function, producer i is interested in maximizing

$${p}_{i} {\int }_{λ} f ( λ ) {\sum }_{x ∈ X * ( p \vert λ )} \frac{{x}_{i}}{\vert X * ( p \vert λ ) \vert} ⅆ λ .$$

Theorem 1.3, Piecewise Constant Solutions. For fixed a, X*(p|λ) changes at only a finite number, n(p), of λvalues. Proof: Suppose p≧0 is given. Then for each x, λγₓCov(T,C)−p′x is linear in λ. Thus maxₓ{λγₓCov(T,C)−p′x} is the max over a finite set of linear functions.

Single Customers, Multiple Producer Levels

If a full food chain, there are multiple levels of pricing decisions. At the first-line level, it is shown how to compute Nash prices. When multiple levels are involved, each level of production is affected by the quality (leading to different posteriors on the mean and variance of the chance variables) and costs (leading to c) of earlier levels.

Start with an illustrative example. Going back to FIG. 18, it can be seen that Intermediary A 1805 has three typical sources of information and Intermediary B1806 uses two sources. For ease of presentation, suppose GOES 1801, Landsat 1802 and the County Stations 1804 each have a fixed price structure, but that intermediaries A 1805 and B 1806 and AVHRR 1803 price competitively.

Suppose industry estimates are available as follows. For GOES 1801, Landsat, AVHRR and the County Stations, there is (in that order):

$$Var ( T ) = ( \begin{matrix}2 & 1.41 & 1.73 & 1 \\ 1.41 & 4 & 0.6 & 0.5 \\ 1.73 & 0.6 & 6 & 1 \\ 1 & 0.5 & 1 & 3\end{matrix} )$$

$$p = ( \begin{matrix}1 \\ 2 \\ ? \\ 3\end{matrix} )$$

$$c = ( \begin{matrix} \\ \\ 1.2 \\ \end{matrix} )$$

$$Cov ( C , T ) = ( \begin{matrix}1 & 1 & 1.5 & 2\end{matrix} ) Var ( C ) = 4$$

COV(C_{A},T)=(1 1 1.5 2)

COV(C_{B},T)=(1 1 1.5 2),

where C is the chance variable of interest to the consumer, C_{A} is of interest to Intermediary A and to Intermediary B. To keep this example simple, assume all of these chance variables are the same. In turn, Intermediary A has the structure determined by the Bayes linear update rules where he decides on which sources to buy (GOES 1801, Landsat 1802, AVHRR) with costs equal to the price he pays plus a fixed, value-added cost c_{A}. Intermediary B decides in a similar fashion between acquiring information from AVHRR and the County Stations. The consumer decides which sources (Intermediary A, B and AVHRR) to purchase). Intermediary A 1805, B 1806 and AVHRR 1803 must decide on the prices.

Let x be the decision vector of the consumer, a be the decision vector of Intermediary A 1805, and b be the decision vector of Intermediary B 1806. The value-added costs for A and B are c_{A}=1 and c_{B}=2, respectively. The profit for AVHRR 1803 is:

p_{AVHRR}(x_{A}a_{AVHRR}+x_{B}b_{AVHRR}+x_{AVHRR})−1.2δ(x_{A}a_{AVHRR}+x_{B}b_{AVHRR}+x_{AVHRR}>0)

The profit for Intermediary A 1805 is:

x_{A}(p_{A}−a_{GOES}−2a_{LANDSAT}−a_{AVHRR}p_{AVHRR}−1)

The profit for Intermediary B 1806 is:

x_{B}(p_{B}−b_{AVHRR}p_{AVHRR}−3bₛₜₐₜᵢₒₙₛ−2)

Finally, the problem of the consumer is

EU*(a,λ|c)=maxₓ{aE(C|x)−λV(C|x)−p*(a,λ)′x.

Thus, the equation above shows what the consumer needs to solve or do to maximize utility.

Referring now to FIG. 19, a a block diagram is shown of an exemplary system 1900 suitable for carrying out embodiments of the present invention. System 1900 comprises a computer system 1910 and a Compact Disk (CD) 1950. Computer system 1910 comprises a processor 1920, a memory 1930 and an optional video display 1940. Computer system 1910 can be used to implement one or more of the consumers, producers, service providers, or electronic marketplace as described in the present invention.

As is known in the art, the methods and apparatus discussed herein may be distributed as an article of manufacture that itself comprises a computer-readable medium having computer-readable code means embodied thereon. The computer readable program code means is operable, in conjunction with a computer system such as computer system 1910, to carry out all or some of the steps to perform the methods or create the apparatuses discussed herein. The computer-readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk, such as compact disk 1950.

Memory 1930 configures the processor 1920 to implement the methods, steps, and functions disclosed herein. The memory 1930 could be distributed or local and the processor 1920 could be distributed or singular. The memory 1930 could be implemented as an electrical, magnetic or optical memory, or any combination of these or other types of storage devices. Moreover, the term “memory” should be construed broadly enough to encompass any information able to be read from or written to an address in the addressable space accessed by processor 1910. With this definition, information on a network is still within memory 1930 because the processor 1920 can retrieve the information from the network. It should be noted that each distributed processor that makes up processor 1920 generally contains its own addressable memory space. It should also be noted that some or all of computer system 1910 can be incorporated into an application-specific or general-use integrated circuit.

Optional video display 1940 is any type of video display suitable for interacting with a human user of system 1900. Generally, video display 1940 is a computer monitor or other similar video display.

It is to be understood that the embodiments and variations shown and described herein are merely illustrative of the principles of this invention and that various modifications may be implemented by those skilled in the art without departing from the scope and spirit of the invention.

What is claimed is:

1. A method for enabling an electronic information marketplace, the method comprising the steps of:
collecting a request from a buyer for a requested information good;
analyzing the request to create additional information from the request;
collecting one or more offered information goods from one or more sellers;
analyzing each of the offered information goods to create additional information from the information good; and
matching the request with at least one of the offered information goods by matching the additional information from the request with the additional information from the at least one information good.

2. The method of claim 1, wherein the step of matching further comprises the step of selecting the at least one offered information goods as a best match.

3. The method of claim 1, wherein the step of matching further comprises the step of matching the request with at least one of the offered information goods by comparing the additional information from the request and the request with the additional information from the at least one information good and the at least one offered information good.

4. The method of claim 1, wherein the step of analyzing the request further comprises the step of analyzing the request to create annotations, and wherein the step of analyzing each of the one or more offered information goods further comprises the step of analyzing each of the one or more offered information goods to create annotations.

5. The method of claim 4, wherein each of the annotations comprises one or more of metadata, semantics, syntactic information, summary information, and model information.

6. The method of claim 1, wherein the step of analyzing the request further comprises the step of creating at least one inference from the request, and wherein the step of analyzing each of the one or more offered information goods further comprises the step of creating at least one inference from each the offered information goods.

7. The method of claim 6, wherein each inference is created through deduction, induction, or abduction.

8. The method of claim 6, wherein the step of analyzing the request further comprises the step of accessing at least one request knowledge model, and wherein the step of analyzing each of the offered information goods further comprises the step of accessing at least one offered knowledge model.

9. The method of claim 1, wherein the step of analyzing the request further comprises the step of accessing at least one request knowledge model, and wherein the step of analyzing each of the offered information goods further comprises the step of accessing at least one offered knowledge model.

10. The method of claim 1, wherein each of the offered information goods has a price associated with the information good and wherein the step of matching further comprises dynamically determining prices of the offered information goods.

11. The method of claim 10, wherein the step of dynamically determining prices further comprises the step of creating an influence diagram comprising nodes and arcs, each arc connecting one node with another node.

12. The method of claim 11, wherein the step of dynamically determining prices further comprises the step of updating expectations and probabilities, defined by the influence diagram, through Bayesian updating or a Bayes linear method selected from a group consisting of linear Bayes updating and updating with decisions.

13. The method of claim 11, wherein the step of dynamically determining prices further comprises the step of maximizing utility.

14. The method of claim 1, wherein each information good comprises a good that can be distributed in digital form.

15. The method of claim 1, further comprising the step of exchanging the at least one offered information good and the requested information good, whereby the buyer has the at least one offered information good and one of the sellers has the requested information good after the exchange.

16. The method of claim 1, wherein:
the step of analyzing the request further comprises the step of annotating the request with annotations comprising one or more of metadata, semantics, syntactic information, summary information, and model information;
the step of analyzing each of the offered information goods further comprises the step of annotating each of the information goods with annotations comprising one or more of metadata, semantics, syntactic information, summary information, and model information;
the method further comprises the steps of:
determining at least one offer inference from the one or more offered information goods; and
determining at least one request inference from the request; and
the step of matching further comprises the step of matching the request with at least one of the offered information goods by comparing the request, and annotations and request inferences of the request, with the offered information goods, and annotations and offer inferences of the offered information goods.

17. The method of claim 16, wherein the step of determining at least one offer inference further comprises the step of determining the at least one offer inference by using one or more of an inductive method, a deductive method, and an abductive method.

18. The method of claim 1, further comprising the step of selecting a trading mechanism from a group consisting of fixed-price, price discrimination, auction, and subscription.

19. The method of claim 1, further comprising the step of decomposing an offering of one of the offered information goods, and wherein the step of matching further comprises the step of comparing decompositions of the one offered information good with the request and the additional information from the request.

20. A system for enabling an electronic information marketplace, the system comprising:
a memory that stores computer-readable code; and
a processor operatively coupled to the memory, the processor configured to implement the computer-readable code, the computer-readable code configured to:
collect a request from a buyer for a requested information good;
analyze the request to create additional information from the request;
collect one or more offered information goods from one or more sellers;
analyze each of the offered information goods to create additional information from the information good; and
match the request with at least one of the offered information goods by matching the additional information from the request with the additional information from the at least one information good.

21. The system of claim 20, wherein the computer-readable code is configured, when analyzing the request, to analyze the request to create annotations, and wherein the computer-readable code is configured, when analyzing each of the one or more offered information goods, to analyze each of the one or more offered information goods to create annotations.

22. The system of claim 21, wherein each of the annotations comprises one or more of metadata, semantics, syntactic information, summary information, and model information.

23. The system of claim 20, wherein the computer-readable code is configured, when analyzing the request, to create at least one inference from the request, and wherein the computer-readable code is configured, when analyzing each of the one or more offered information goods, to create at least one inference from each the offered information goods.

24. The system of claim 23, wherein each inference is created through deduction, induction, or abduction.

25. The system of claim 20, wherein the computer-readable code is configured, when analyzing the request, to of access at least one request knowledge model, and wherein the computer-readable code is configured, when analyzing each of the offered information goods, to access at least one offered knowledge model.

26. The system of claim 20, wherein each of the offered information goods has a price associated with the information good and wherein the computer-readable code is configured, when matching, to dynamically determine prices of the offered information goods.

27. The system of claim 26, wherein the computer-readable code is configured, when dynamically determining prices, to create an influence diagram comprising nodes and arcs, each arc connecting one node with another node.

28. The system of claim 27, wherein the computer-readable code is configured, when dynamically determining prices, to update expectations and probabilities, defined by the influence diagram, through Bayesian updating or a Bayes linear method selected from a group consisting of linear Bayes updating and updating with decisions.

29. The system of claim 27, wherein the computer-readable code is configured, when dynamically determining prices, to maximize utility.

30. The system of claim 20, wherein each information good comprises a good that can be distributed in digital form.

31. The system of claim 20, wherein the computer-readable code is further configured to exchange the at least one offered information good and the requested information good, whereby the buyer has the at least one offered information good and one of the sellers has the requested information good after the exchange.

32. The system of claim 20, wherein the computer-readable code is further configured to decompose an offering of one of the offered information goods, and wherein the computer-readable code is configured, when matching, to compare decompositions of the one offered information good with the request and the additional information from the request.

33. An article of manufacture comprising:
a computer-readable medium having computer-readable code means embodied thereon, the computer-readable code means comprising:
a step to collect a request from a buyer for a requested information good;
a step to analyze the request to create additional information from the request;
a step to collect one or more offered information goods from one or more sellers;
a step to analyze each of the offered information goods to create additional information from the information good; and
a step to match the request with at least one of the offered information goods by matching the additional information from the request with the additional information from the at least one information good.

34. The article of manufacture of claim 33, wherein the computer-readable code means further comprises, when analyzing the request, a step to analyze the request to create annotations, and wherein the computer-readable code means further comprises, when analyzing each of the one or more offered information goods, a step to analyze each of the one or more offered information goods to create annotations.

35. The article of manufacture of claim 34, wherein each of the annotations comprises one or more of metadata, semantics, syntactic information, summary information, and model information.

36. The article of manufacture of claim 33, wherein the computer-readable code means further comprises, when analyzing the request, a step to create at least one inference from the request, and wherein the computer-readable code means further comprises, when analyzing each of the one or more offered information goods, a step to create at least one inference from each the offered information goods.

37. The article of manufacture of claim 36, wherein each inference is created through deduction, induction, or abduction.

38. The article of manufacture of claim 33, wherein the computer-readable code means further comprises, when analyzing the request, a step to of access at least one request knowledge model, and wherein the computer-readable code means further comprises, when analyzing each of the offered information goods, a step to access at least one offered knowledge model.

39. The article of manufacture of claim 33, wherein each of the offered information goods has a price associated with the information good and wherein the computer-readable code means further comprises, when matching, a step to dynamically determine prices of the offered information goods.

40. The article of manufacture of claim 39, wherein the computer-readable code means further comprises, when dynamically determining prices, a step to create an influence diagram comprising nodes and arcs, each arc connecting one node with another node.

41. The article of manufacture of claim 40, wherein the computer-readable code means further comprises, when dynamically determining prices, a step to update expectations and probabilities, defined by the influence diagram, through Bayesian updating or a Bayes linear method selected from a group consisting of linear Bayes updating and updating with decisions.

42. The article of manufacture of claim 40, wherein the computer-readable code means further comprises, when dynamically determining prices, a step to maximize utility.

43. The article of manufacture of claim 33, wherein each information good comprises a good that can be distributed in digital form.

44. The article of manufacture of claim 33, wherein the computer-readable code means further comprises a step to exchange the at least one offered information good and the requested information good, whereby the buyer has the at least one offered information good and one of the sellers has the requested information good after the exchange.

45. The article of manufacture of claim 33, wherein the computer-readable code means further comprises a step to decompose an offering of one of the offered information goods, and wherein the computer-readable code means further comprises, when matching, a step to compare decompositions of the one offered information good with the request and the additional information from the request.
